(19) United States
(12) Patent Application Publication
(10) Pub. No.: US 2024/0072877 A1
(43) Pub. Date: Feb. 29, 2024

(54) RESTRICTED RECEIVE BEAMSWEEPING FOR HIGH-SPEED USER EQUIPMENT

(71) Applicant: Telefonaktiebolaget LM Ericsson (PUBL), Stockholm (SE)

(72) Inventors: Christopher CALLENDER, Kinross (GB); Muhammad Ali KAZMI, Sundbyberg (SE); Kazuyoshi UESAKA, Kawasaki Kanagawa (JP); Thomas CHAPMAN, Solna (SE); Joakim AXMON, Limhamn (SE)

(21) Appl. No.: 18/261,431

(22) PCT Filed: Jan. 13, 2022
(86) PCT No.: PCT/EP2022/050694

§ 371 Date: Jul. 13, 2023

Related U.S. Application Data
(60) Provisional application No. 63/137,829, filed on Jan. 15, 2021.

(51) Int. Cl. H04B 7/08

(52) U.S. Cl. CPC H04B 7/088

(57) ABSTRACT

A method (1200) by a wireless device (110) operable to perform receive beam sweeping over a set of a plurality of receive beams includes receiving (1202), from a network node, assistance information. The wireless device determines (1204), based on the assistance information, a first subset of receive beams within the set of the plurality of receive beams. The wireless device performs (1206) at least one operation based on the first subset of receive beams.

### TECHNICAL FIELD

The present disclosure relates, in general, to wireless communications and, more particularly, systems and methods for restricted receive beamsweeping for high-speed User Equipment (UE).

### BACKGROUND

In 3^{rd} Generation Partnership Project (3GPP) Release 15 and Release 16, radio resource management (RRM) requirements have been specified for frequency range FR1 and frequency range FR2. In FR2 operations, there has been an assumption that wireless devices such as User Equipments (UEs) perform receive beamforming on received signals including the signals used for radio resource management.

As the UE may be unaware of the direction of arrival of a received signal from a neighbour cell, or even from the serving cell if it is not quasi collocated (QCL) with another signal with already known direction of arrival, the UE RRM requirements for FR2 allow markedly longer measurement time than for FR1, which gives the UE sufficient time to attempt to perform RRM measurements with different receive beams such that it may, for example, sweep through a number of possible receive beams and base the final measurement result on the samples obtained when the best receive beams were used.

FIG. 1 illustrates an example of two UEs performing measurements on a Synchronization Signal (SS) burst. Specifically, in FIG. 1, a network node such as gNodeB (gNB) transmits so called synchronization blocks consisting of primary synchronization sequence (PSS), secondary synchronization sequence (SSS), primary broadcast channel (PBCH) and demodulation reference symbols for PBCH (PBCH-DMRS). In the example in FIG. 1, eight different synchronization blocks are transmitted within each SS burst, although the New Radio (NR) standard supports up to L=64 synchronization blocks for FR2. It should be noted that the different synchronization blocks may be differently transmit beamformed by the gNB; however, this should not be confused with receive beamforming which is the main subject of this disclosure. The UE may detect different SS blocks, may perform time index determination for detected SS blocks, and may perform measurements on detected SS blocks. Examples of measurements performed on SS blocks include Secondary Sync-Reference Symbol Received Power (SS-RSRP), Secondary Sync-Reference Symbol Received Quality (SS-RSRQ) and Secondary Sync-Signal to Noise and Interference Ratio (SS-SINR).

When receiving the SS blocks, UEs are also expected to perform receive beamforming. FIG. 2 illustrates typical UE implementations that perform analogue beamforming. Future UE implementations may use hybrid or digital beam forming, in which the phase shifting operation depicted in FIG. 2 is moved partially or fully to the digital domain.

As depicted in FIG. 2, the receive waveform is received by an array of antenna elements. Different arrangements for antenna array and antenna elements may be contemplated. For example, in one arrangement, the array may consist of a rectangular arrangement of antenna elements, denoted as an M×N array, where M and N are the number of elements in each direction of the rectangle. In order to provide coverage in all directions, the UE may consist of several such M×N arrays, each pointing in a different direction. The UE may activate the most appropriate one of the M×N arrays based on or otherwise in consideration of the direction of the received signal.

The received signals from each antenna element are subject to an analogue phase shift, the phase of each phase shifter being controllable by the UE, and then the signals from the different antenna elements are combined before being converted from analogue to digital signals by an analogue to digital converter (ADC) and further processed in digital baseband. FIG. 2 is highly simplified and only shows the essential elements of UE reception from a beamforming perspective. Typically, control of each phase shift is achieved by applying a control voltage that determines the magnitude of phase shift that will be obtained.

By controlling the various phase shifters in the antenna array, antenna gain can be obtained in a particular spatial direction. This antenna arrangement is known as an active antenna and has the characteristic that the receive direction (i.e. the direction in which the active antenna can receive with large gain) can be electrically steered in different directions depending on the settings of the set of phase shifters.

Generally speaking, the UE will be unaware of the direction of arrival of a signal. For example, when first detecting a new signal from a neighboring network node, the UE does not know the relative location of the network node to itself or the propagation condition (e.g. line of sight (LOS), non-line of sight (non-LOS) etc.) from the network node to the UE. Even if the UE has already detected or measured the same signal previously, the UE's own orientation may have changed between the two measurements (especially true in a portable or handheld device), or propagation conditions may have changed, the UE may have moved, or the UE may turn around.

In such cases where the UE does not know the direction of arrival of the signal, and thus how to configure the receive beamforming phase shifters to receive the signal in an optimal manner, the UE performs a procedure known as receive beam sweeping. The UE attempts to receive the signal assuming different possible directions of arrival and then determines which directions are successful, or which offer the best possible measurements. This is achieved by cycling the phase shifters through different settings and determining the measurement outcome for each attempted direction of arrival. For example, a linear antenna array in 2 dimensions could be configured to perform receive beam sweeping to try receiving from −45 degrees, 0 degrees, and 45 degrees to its boresight direction. In practice, a rectangular antenna array is capable of sweeping in 3D space and can have its receive direction controlled in both azimuth and elevation. Practical UEs also often have multiple receiver panels (each panel being a separate antenna array) with the panels having different boresight directions as well as each panel being electrically steerable as depicted in FIG. 2. In addition, the individual antenna elements are often optimized to receive RF signals of particular polarization, and each antenna element may consist of two sub-elements which receive from polarization 90 degrees apart.

The set of control signals applied to all the phase shifters to receive beamform in a particular direction is sometimes known as a codeword, and the group of all possible codewords that is used to steer the active antenna system in all possible directions is known as a codebook. Hence, it can be said that to perform a beam sweep, the UE should cycle through all the codewords in the code book.

Many aspects of the antenna design, including the number of code words in the codebook, the geometry of the antenna array, the design of the antenna elements, and the design of the codewords themselves are not standardized but rather left for UE implementation. So, for example, a UE may use a smaller number of wide receive beams, resulting in a smaller code book size and more modest antenna gain, or a larger number of narrow receive beams, which would provide greater antenna gain but at the expense of taking longer to complete a receive beam sweep. Spherical coverage requirements are specified by RAN4 Radio Frequency (RF) specifications, which refer to a percentage of the sphere around the UE over which a certain receiver performance should be obtained. For example, it may be said that a UE achieves 80% spherical coverage if it meets a receiver requirement over 80% of the sphere which surrounds it.

To allow sufficient time for such receive beamsweeping, a scaling factor or an increased detection/measurement time is applied in many RRM requirements for FR2 compared with their FR1 counterparts. For example, in idle reselection delays, a scaling factor of N=8 is allowed, and in RRC connected RRM requirements an increased number of samples is allowed which depends on UE power class (related to spherical coverage requirements). Tables 1 and 2 are examples of scaling factors N, assuming UE receive beam forming, specified in 3GPP TS38.133 V16.5.0. In this specification, the difference of the evaluation periods T_{Evaluate_out_SSB} and T_{Evaluate_in_SSB} between Table 1 for FR1 and Table 2 for FR2 is the scaling factor, where RAN4 assumes N=8 for T_{Evaluate_out_SSB} and T_{Evaluate_in_SSB}.

TABLE 1
Evaluation period T_{Evaluate}_{_{—}}ₒᵤₜ_{_{—}}_{SSB} and T_{Evaluate}_{_{—}}ᵢₙ_{_{—}}_{SSB} for FR1

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | Max(200, Ceil(10 × | Max(100, Ceil(5 × |
| | P) × T_{SSB}) | P) × T_{SSB}) |
| DRX | Max(200, Ceil(15 × | Max(100, Ceil(7.5 × |
| cycle ≤ 320 ms | P) × Max(T_{DRX}, T_{SSB})) | P) × Max(T_{DRX}, T_{SSB})) |
| DRX | Ceil(10 × P) × T_{DRX} | Ceil(5 × P) × T_{DRX} |
| cycle > 320 ms | | |

NOTE:
T_{SSB} is the periodicity of the SSB configured for RLM. T_{DRX} is the DRX cycle length.

TABLE 2
Evaluation period T_{Evaluate}_{_{—}}ₒᵤₜ_{_{—}}_{SSB} and T_{Evaluate}_{_{—}}ᵢₙ_{_{—}}_{SSB} for FR2

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | Max(200, Ceil(10 × | Max(100, Ceil(5 × |
| | P × N) × T_{SSB}) | P × N) × T_{SSB}) |
| DRX | Max(200, Ceil(15 × | Max(100, Ceil(7.5 × |
| cycle ≤ 320 ms | P × N) × | P × N) × |
| | Max(T_{DRX}, T_{SSB})) | Max(T_{DRX}, T_{SSB})) |
| DRX | Ceil(10 × P × | Ceil(5 × P × |
| cycle > 320 ms | N) × T_{DRX} | N) × T_{DRX} |

NOTE:
T_{SSB} is the periodicity of the SSB configured for RLM. T_{DRX} is the DRX cycle length.

In 3GPP Release 17, a work item has been started to support high speed train operation in FR2. This work will specify NR UE RF requirements, UE RRM requirements, and base station (BS)/UE performance requirements for high speed train scenario with up to 350 km/h in Release 17. The work relates to the following scenarios:
NR SA single carrier scenario in FR2
Focused on train roof-mounted high-power devices
   Single panel, i.e. only one active antenna panel at a time, as baseline antenna assumption
The target applicable frequency is up to 30 GHz. The candidate frequency bands including band n261, n257 and n258. Target deployment scenario is multi-RRHs share the same cell-ID, the detailed parameters will be investigated and decided in initial phase of WI:
   Number of RRHs per cell
   The distance between adjacent RRHs
   The distance between RRHs and railway track
   The number of SSB per RRH

As indicated, the UEs for high speed FR2 operation are typically mounted on the roof of a high speed train and provide Internet connectivity to passengers on the train, often using another radio interface within the train, such as WiFi, to connect to the users. However, it is the NR link between the roof mounted UE, and the trackside gNB which is considered in the 3GPP work item. There may be different arrangements of UE on the train, such as one UE per train providing internet services to all the passengers in the train, or one UE per train carriage and so on. The exact details of deployment are an ongoing topic in 3GPP.

Certain problems exist, however. For example, as discussed above, additional delay is allowed in RRM requirements on FR2 compared to FR1 to allow the UE to perform receive beam sweeping and attempt to measure in multiple receive directions to determine which direction is preferred. However, in a high speed scenario, these additional delays cannot be tolerated. For example, if a UE reaches a cell edge where it should send a measurement report triggering handover, a long delay in performing the measurement may result in call drop before the UE sends the report and the network can react to it with an RRC message implying handover. UE RRM delays need to be improved to give acceptable system performance, which may be measured using KPIs such as handover failure rate, radio link failures, etc.

### SUMMARY

Certain aspects of the present disclosure and their embodiments may provide solutions to these or other challenges. For example, according to certain embodiments, methods and systems are provided that make assistance information available to a wireless device such that the wireless device can make a more informed decision on how many different directions to perform receive beam sweeping for RRM operations in, and in which sequence to perform them.

According to certain embodiments, a method by a wireless device operable to perform receive beam sweeping over a set of a plurality of receive beams includes receiving, from a network node, assistance information. The wireless device determines, based on the assistance information, a first subset of receive beams within the set of the plurality of receive beams. The wireless device for performs at least one operation based on the first subset of receive beams.

According to certain embodiments, a wireless device for performing receive beam sweeping over a set of a plurality of receive beams is adapted to receive assistance information from a network node. The wireless device is adapted to determine, based on the assistance information, a first subset of receive beams within the set of the plurality of receive beams. The wireless device is adapted to perform at least one operation based on the first subset of receive beams.

According to certain embodiments, a method by a network node operable to assist a wireless device in performing receive beam sweeping over a set of a plurality of receive beams includes transmitting, to the wireless device, assistance information for determining by the wireless device a first subset of receive beams within the set of the plurality of receive beams for performing receive beam sweeping.

According to certain embodiments, a network node operable to assist a wireless device in performing receive beam sweeping over a set of a plurality of receive beams is adapted to transmit, to the wireless device, assistance information for determining by the wireless device a first subset of receive beams within the set of the plurality of receive beams for performing receive beam sweeping.

Certain embodiments may provide one or more of the following technical advantages. For example, one technical advantage may be that certain embodiments provide information to the wireless device that allows the wireless device to restrict the different directions in which it performs RX beamsweep, and the sequence in which it beam sweeps. The predictability of the scenario and knowledge of key deployment parameters may enable RRM operations such as measurements to be completed more rapidly.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of two UEs performing measurements on a SS burst;

FIG. 2 illustrates typical UE implementations that perform analogue beamforming;

FIG. 3 illustrates an example of a high speed train deployment, according to certain embodiments;

FIG. 4 illustrates a train roof mounted UE supporting RX beams in other directions, according to certain embodiments;

FIG. 5 illustrates an example wireless network, according to certain embodiments;

FIG. 6 illustrates an example network node, according to certain embodiments;

FIG. 7 illustrates an example wireless device, according to certain embodiments;

FIG. 8 illustrate an example user equipment, according to certain embodiments;

FIG. 9 illustrates a virtualization environment in which functions implemented by some embodiments may be virtualized, according to certain embodiments;

FIG. 10 illustrates a telecommunication network connected via an intermediate network to a host computer, according to certain embodiments;

FIG. 11 illustrates a generalized block diagram of a host computer communicating via a base station with a user equipment over a partially wireless connection, according to certain embodiments;

FIG. 12 illustrates a method implemented in a communication system, according to one embodiment;

FIG. 13 illustrates another method implemented in a communication system, according to one embodiment;

FIG. 14 illustrates another method implemented in a communication system, according to one embodiment;

FIG. 15 illustrates another method implemented in a communication system, according to one embodiment;

FIG. 16 illustrates an example method by a wireless device, according to certain embodiments;

FIG. 17 illustrates an example virtual apparatus, according to certain embodiments;

FIG. 18 illustrates another example method by a wireless device, according to certain embodiments;

FIG. 19 illustrates an example method by a network node, according to certain embodiments; and

FIG. 20 illustrates another example virtual apparatus, according to certain embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc.), O&M, OSS, SON, positioning node (e.g. E-SMLC), MDT, test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

According to certain embodiments, methods and systems are provided that make assistance information available to a wireless device, which may include a UE in particular embodiments, such that the wireless device can make a more informed decision on how many different directions to perform receive beam sweeping for RRM operations in, and in which sequence to perform them.

As another example, according to certain embodiments, a wireless device may predict which beams to measure based on external aspects made known to the wireless device, such as network layout, train trajectory and train speed.

According to certain embodiments, a wireless device may receive signaled information indicating that the wireless device is in a high speed train environment such that the wireless device can adapt its behavior and meet different requirements. Additionally or alternatively, the wireless device may signal to the network, via a network node, that it belongs to a specific class of wireless devices that are train mounted such that the network is aware that it meets different RRM requirements and is basing its measurements on a more limited coverage than other types of UE.

In high speed operations with a wireless device mounted on a roof of a vehicle such as, for example, a high speed train, the possible orientations relative to the trackside gNB are very limited compared to a handheld UE which can be moved around freely. In addition, where the vehicle is a train, the train typically operates on a track. Thus, roof mounted UEs follow a fixed, predictable and repeatable path which gives them less freedom in where they can be relative to a trackside gNB, compared to UEs in other types of vehicles. Indeed, if the gNB is close to the track, then the gNB is almost always almost directly ahead of the UE, or directly behind the UE, except for the brief moment when the UE passes the trackside gNB. As a result, there is significantly less need for a UE to perform RX beam sweeping in many different directions, and even if the preferred beam direction changes to a new codeword, the change and the sequence of changes (sequence of best beams) is likely to be very predictable as the UE moves past the trackside gNB sites.

There is, nevertheless, freedom for operators and deployers of trackside network node such as, for example, a gNB, to make some choices in the deployment. For example, even if 3GPP determines to use a certain gNB to railway track distance, it can happen that a particular gNB is installed at a different distance from the track than 3GPP assumption, perhaps due to local constraints or a wider section of track at a junction, etc.

Certain embodiments described herein take advantage of the fact that the receive directions to measure by the wireless device will be limited and known to reduce the amount of measurements that the wireless device needs to perform and, thus, the measurement time.

According to certain embodiments, assistance information is made available to the wireless device such that it can make a more informed decision on how many different directions in which to perform receive beam sweeping for RRM operations and in which sequence to perform them.

According to certain embodiments, assistance information enables the wireless device to predict and/or determine which beams to measure based on external aspects made known to the wireless device, such as network layout, train trajectory, and vehicle speed.

According to certain embodiments, the wireless device may be signaled that it is in a high speed vehicle environment. In response, the wireless device can adapt its behavior and meet different requirements. Additionally or alternatively, the wireless device may signal to the network that the wireless device belongs to a specific class of wireless devices that are train mounted such that the network is aware that it meets different RRM requirements and is basing its measurements on a more limited coverage than other types of wireless devices.

According to certain embodiments, the techniques, methods and systems disclosed herein consist of several related aspects:
1. UE determination of a restricted set of receive beams over which to perform receive beam sweeping over in RRM operations.
2. Assistance in the determination of the restricted set of receive beams using estimated UE position/speed, geographical knowledge of network deployment, RRH antenna position, and optionally, assistance related to train route and assistance on RRH to track distance.
3. Reduction of required delays in RRM due to restricted set of received beams

The embodiments are more relevant for mmwave (e.g., FR2) however they are applicable to any frequency in which the UE needs to perform receive beamsweeping or tracking beams of signals from one or more cells. Examples of frequencies within frequency range 2 (FR) may vary between 24 GHz to 52.6 GHz. The embodiments may therefore also apply to frequencies below FR2 or above FR2 e.g. above 52.6 GHz.

In general, high speed and/or a high speed vehicle refers to a speed of a UE above a certain speed threshold. The speed and corresponding speed threshold can be expressed in terms of distance per unit time (e.g. X1 km/hour, X2 m/s, X3 miles/hours etc) or it may be expressed in terms of Doppler frequency (e.g. Y1 Hz, Y2 kHz etc). The Doppler frequency may further depend on UE speed and the carrier frequency on which the UE operates (e.g. transmit and receive signals). Examples of speed thresholds are Z1 km/hour, Z2 Hz. In one example speed is considered high speed if the speed is above Z1 km/hour (e.g. 120 km/hour). In another example speed is considered high speed if the Doppler frequency is above Z2 Hz (e.g. 2000 Hz).

The three example embodiments described above are described in more detail below.

UE Determination of a Restricted Set of Receive Beams Over which to Perform Receive Beam Sweeping Over in RRM Operations.

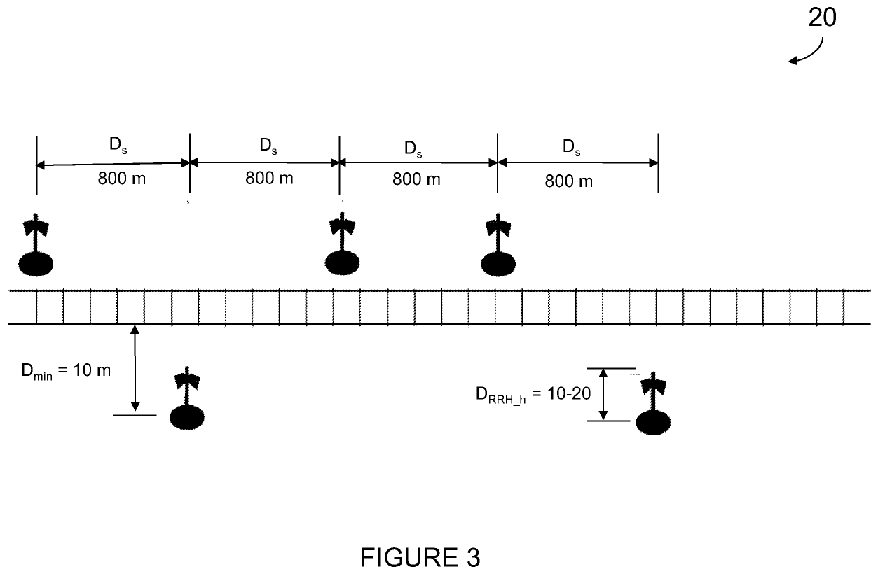

FIG. 3 depicts an example 20 of a high speed train deployment, according to certain embodiments. It is generally recognized, however, that though a train deployment is provided as an example the same example may be applied to any other type of high speed vehicle deployment. Additionally, the parameters such as Dmin, Ds, Drrh_h are given as examples, although in practice other values could be used. Since the distance between sites (e.g. Remote Radio Head (RRH), Transmit Point (TRP), TRxP, antenna sites) (Ds) is large compared with the gNB to track distance (Dmin) and the RRH vertical height (Drrh_h), it can be understood that for most positions on the track, the RRH is either almost directly ahead of, or almost directly behind the UE. Given this scenario, a wireless device such as a UE may determine to receive only from spatial directions directly ahead of, or directly behind the train. Naturally, as the train passes a trackside RRH, there will be some time when the RRH is to the side of the train, but this time will be short especially as the train is travelling at high speed.

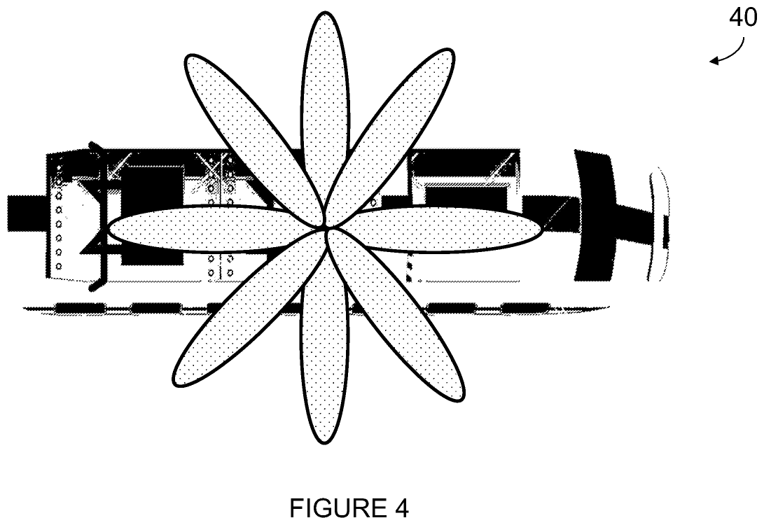

Nevertheless, it may be desirable to perform measurements on signals (e.g. SSB) transmitted by the RRH as the train mounted UE passes the site. FIG. 4 depicts an example 40 beam sweeping arrangement of a train roof mounted UE supporting RX beams, according to certain embodiments.

If we assume that the UE is moving towards an RRH site from some distance away, the signals of the RRH may be detected and measured with beam 1 (e.g. SSB1) as it points directly ahead. At some time, as the UE starts to become closer to the RRH, the UE shall start to use either RX beam 2 or beam 8, depending on which side of the train the RRH has been installed. If we assume that beam 3 becomes the proper choice, then it is clear that the UE will subsequently need to use beams 4 and finally beam 5 as the train moves past the RRH. Similarly, if beam 8 becomes the proper choice then the UE can next be expected to use beam 7, then beam 6, and then finally beam 5.

Based on the example in FIG. 4, it is clear that if the UE is already using beam 2 (meaning that the RRH being measured is close to, and somewhat ahead of the train on the left hand side relative to the train's motion), there would be very little value in attempting to measure any of the beams on the right hand side of the train, and indeed, measurements on beam 4 and beam 5 would be of limited usefulness until such time as the train had first measured the RRH with beam 3. In this situation, the UE has good knowledge of the likely next beam due to its own fixed orientation relative to the train and the fixed movement of the train along a constrained railway route. With reference to FIG. 4, it can be seen that although the UE is capable of receiving from 8 different spatial directions, at no moment in time does the UE need to consider more than the current best receive beam and one or two other receive beams which can be predicted based on the UE movement along the track. As RRM measurement delays scale according to the number of receive beams, this represents a very considerable advantage in terms of shortening the measurement delay (e.g. RSRP measurement period, cell identification delay, L1-RSRP/L1-SINR measurement period radio link monitoring, beam management, etc), as compared with the situation where the UE is checking the beam in all 8 directions.

Thus, according to certain embodiments, the candidate receive beams to consider by the UE are restricted compared to the full set of possible receive beams, using knowledge of the currently used receive beam, the spatial arrangement of other possible receive beams, and a knowledge that the UE is mounted in a fixed way on a vehicle which follows a highly constrained route (such as railway track).

As used herein, the term RRH is used generically. A RRH is provided as just one example of a network node, and it is generally recognized that any of the methods and techniques described herein as relating to a RRH may equally apply to other types of network nodes.

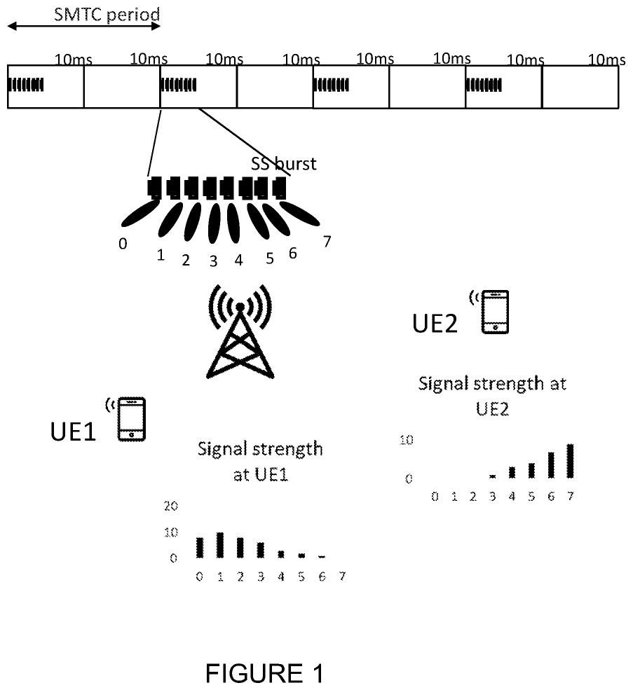

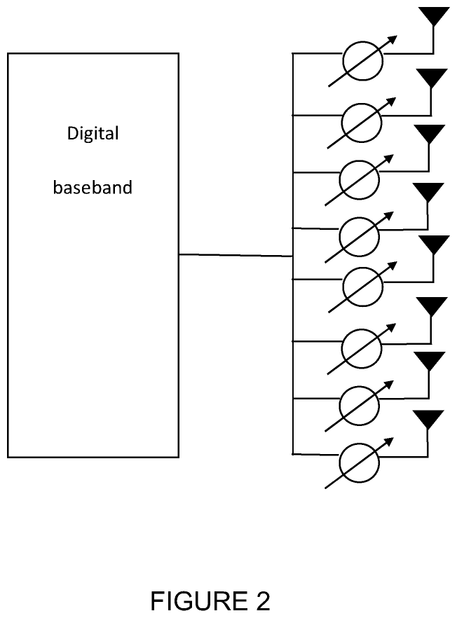

Further, all RRH in a group of RRH typically have the same physical cell ID (PCI). In this case, the RRH may use different time indices within the SS burst (see FIG. 1 described above) such that when the UE measures and reports each particular time index, the meaning is that it is measuring a different RRH. In this case, it is clear that the UE could be moving towards some RRH and away from other RRH, so considering the entire SS burst it may perform measurements of different indices with different RX beam sweeping strategies. It is also almost certain that it is only ever passing by the side of a single RRH, so with reference to FIG. 4, if one SSB is being measured with RX beam 2,3,4, 6,7 or 8 the UE may expect to be able to measure all other SSB with either beam 1 (ahead direction) or beam 5 (behind direction). This knowledge may be further used to determine the restricted beam set to use.

As the UE may not wish to change receive beam sweeping within a single SS burst (depending on implementation) an alternative embodiment is to first determine the set of possible candidate beam directions for each RRH (using the previously described inventive steps) and then to perform a restricted beam sweep over a set of directions which is the union of the directions needed to receive from each individual RRH. As an example, if the UE determined that it can receive a first RRH (RRH1) with beam 1, and it can receive a second RRH (RR2) with beam 8 while also attempting to measure on beam 1 as a probable next beam (i.e. it is passing RRH2), then the union of measurements would involve directions 1, 8 and 2. Thus, the UE would perform receive beam sweeping according to a sequence such as 1, 8, 2, 1, 8, 2, . . . . In this case, the measurements of RRH1 with beam 8 and 2 are not expected to be useful, because the UE is passing RRH2 and therefore is not also passing RRH1 (assuming them to be installed at different locations), hence RRH1 could not be to the side of the train. However, the measurement delays are still markedly lower than if the UE performed RX beam sweep over all possible directions 1, 2, 3, 4, 5, 6, 7, 8 as would be done using previous receive beam sweep techniques.

According to certain embodiments, the different RRH may correspond to different cells, namely using a different physical cell ID. This may happen, for example, when the UE moves from an area where the next group of RRHs are connected to a different gNB. This may be dealt with in a very similar way to the different time indices, namely the UE would determine which candidate receive beam(s) it needed to use for each PCI and then perform receive beam sweeping over the union of all candidate receive beam directions, again noting that it can only be passing one site at a time, and hence all other PCI can be measured either almost directly ahead of, or directly behind the UE.

The selection of candidate beam directions has so far assumed that the track is straight. If we imagine the UE approaching or moving away from an RRH on a curved track, the first beam may not be the one directly ahead of the train. Considering the high speed nature of the railway track, and the need to space FR2 RRH relatively close together (shown as Ds in FIG. 3, e.g., 800 meters), very tight turns over short distances are not particularly feasible due to the high speed usage. However, this can also be taken into account in the candidate receive beam selection, by increasing somewhat the consideration of possible candidate beams. The number of candidate beams considered by the UE may be fixed, or the number of candidate beams may depend on the speed at which the train and, thus, the UE, is moving. According to the latter scenario, more candidate beams may be considered when the speed is lowered such as, for example, due to train passing train station areas, switching areas, urban areas, or tight curves. These may be places where it may be challenging to deploy RRHs at the same distance from the track as otherwise used or, for example, tangential to the direction in which the train is moving. Further enhancement would be possible using knowledge of the geographical arrangement of the railway track and train route, and location based enhancement is covered in the next section.

Assistance in the Determination of the Restricted Set of Receive Beams Using, for Example, Estimated UE Position/Speed, Geographical Knowledge of Network Deployment, RRH Antenna Position, and Optionally, Assistance Related to Train Route and Assistance on RRH to Track Distance

There are various ways in which the determination of the restricted set of receive beams can be enhanced using estimated UE position, with the purpose of minimizing the set of candidate receive beams to consider and hence reducing RRM measurement delays. For example, according to certain embodiments, the UE may be equipped with a Global Navigation Satellite System (GNSS) receiver (e.g., GPS receiver), and be aware of its position and speed, or may be informed of its position and speed from onboard control systems on the train or other vehicle, or in any other way and using any positioning technology. The UE may also be aware of the route the UE is following on the track, and the layout of the cellular network on the railway deployment, in particular embodiments, and as shown in FIG. 3. This may be referred to as train trajectory, train deployment, or layout information etc.

According to certain embodiments, the information may therefore comprise one or more parameters such as Dmin, Ds, Drrh_h, geographical coordinated of location of RRH or another network node. The information may, therefore, enable the UE to determine location of the RRH and the direction to the closest RRH as it moves along the train, for example. Examples of such information include a database and/or map providing information on the location of RRH sites and information about the transmitted beam(s) being used by each RRH. In particular, such information may include a direction of transmission or time index and/or the physical cell ID being used by each RRH. The train deployment or layout information can be pre-configured in the UE (e.g. in SIM/USIM card) or it can be configured by the network node, which may include a base station, in a particular embodiment. Alternatively, the train deployment or layout information can be configured from the train traffic control system. In a particular embodiment, for example, the UE may be configured or pre-configured with the train deployment or layout information. The UE may be further provided with an indication of 1) when the UE should adapt its beam sweeping for measurements (e.g. restrict beamsweeping) based on the configured layout or 2) when the UE is not allowed to restrict beamsweeping for measurements (i.e. apply legacy beamsweeping).

According to previous methods for beamsweeping, the UE performed a sweep of all its RX beams (e.g., 8 Rx beams) to detect the beam from RRH. According to certain embodiments disclosed herein, however, when the UE is approaching a train station or is static, the UE can be signaled or otherwise indicated that the UE should not restrict beamsweep and, thus, should apply previous methods for beamsweeping. Alternatively, according to certain embodiments, the UE may determine whether to apply restricted or unrestricted (legacy) beamsweeping based on determined train speed (UE speed) (or via any proxy for speed such as Doppler shift, number of beam or RRH changes per some time unit, etc.).

In a particular embodiment, the UE can be configured with information about a plurality of train deployment or layouts. For example, the UE can be configured with 2 different layouts. In a particular embodiment, for example, the 2 different layouts may differ in terms of Dmin such as, for example where Dmin=4 m in first layout and Dmin=10 m in a second layout. The first layout may be used in a tunnel and the second layout may apply in open area. The UE may further be signaled or otherwise indicated by the network node with an indication of which one of the plurality of train layouts is to be used by the UE for adapting its beamsweeping. For example, when operating in an area related to the first layout, the UE may sweep fewer beams (e.g. 2 Rx beams). Conversely, when operating in an area related to the second layout, the UE may sweep more beams (e.g. 4 Rx beams).

With knowledge of the position of the UE and relative position of the RRH, the UE can predict which receive beam to use to perform RRM operations and, thus, the number of candidate RX beams can be reduced, even to a single candidate, based on the UE position. In an extreme implementation, the UE could in some stretches of track omit to do RRM measurements altogether and rely on knowledge of the train position, speed, and beam patterns. Alternatively, in the event of a radio link failure, the UE could reduce the time needed to re-establish connection by predicting which beam is the optimum one based on knowledge of the track layout and the UE's position and speed.

According to certain embodiments, the determination of UE position and RRH position may be performed in a network node rather than in the UE. Since the network may not be aware of the exact RX antenna configuration (array size, UE RX beamforming codebook entries, etc.), which is a UE implementation issue, the network node may indicate to the UE which receive beam to use, in certain embodiments. However, the network node may signal or otherwise indicate, for example, a relative angle (2D) or angles (3D) from the UE's current position to the RRH which the UE may further use to select or assist to select a restricted set of candidate receive beams that will be used in the receive beam sweep.

In a particular embodiment, another form of assistance information may be provided to indicate to the UE the distance from the RRH to the track. This information may be provided either for a localized area or for a wider part of the network, in particular embodiments. There may be areas in which the RRH to track distance becomes very small, such as in a tunnel, and in these cases the UE passes the trackside node in an extremely short time such that the RRH or other network node is almost always directly ahead or directly behind the UE. In such cases, it may be reasonable not to measure on any receive beam not operating in the directly ahead or directly behind situation because the time in which the UE could beneficially use any other beam is extremely transient. Equally, when the RRH to track distance becomes large, which may occur for, for instance, at a junction or an area where there are more parallel tracks, it can be beneficial for the UE to consider more candidate beams.

In general terms, this is expressed as an optional embodiment in either network or UE whereby the candidate receive beams to consider are restricted compared to the full set of possible receive beams, using estimates of the UE location and geographical knowledge of the network deployment, and, optionally, knowledge of train route.

This may be used in addition to, or as an alternative to the previous method.

### Reduction of Required Delays in RRM Due to Restricted Set of Received Beams

Based on the restricted set of received beams, the UE can perform RRM operations (e.g. RSRP measurement, beam detection, cell detection, etc.) more quickly, either based on its autonomous actions or assistance information or both. For example upon receiving an indication from the network node or autonomously determining that the UE is operating in high speed train, the UE may adapt its beamsweeping for measurements. For example, the UE may reduce the number of RX beamsweeps compared to reference number of beamsweeps, in a particular embodiment.

The reference number of beamsweeps may refer to legacy number of beamsweeps such as, for example, 8 RX beams when the UE sweeps all its RX beamsweeps. In a particular embodiment, the indication may comprise a flag (e.g., high speed flag, high speed flag for mmwave, high speed flag for FR2, etc.) signaled to the UE indicating that the UE is operating at high speed. For example, the indication may be signaled to the UE when the train is moving at a certain speed or within certain speed range. For example the flag may indicate the UE speed (e.g. 300 km/hour) or UE speed range (e.g. 200-300 km/hr, 300 km/hour or above, etc.).

According to certain embodiments, the flag may indicate the UE Doppler frequency (e.g. 2 kHz) or UE Doppler frequency range (e.g. 2-6 kHz or above 6 kHz etc).

In a particular embodiment, the train mounted device may be constructed with fewer panels and/or fewer beam directions than other types of UEs, due to a reduced need to provide spherical coverage. Such train mounted UEs may need to be treated as different UE classes in RAN4 specifications (i.e., a HST UE class) with different RRM and RF requirements.

In a particular embodiment, the UE may also signal to the network that it belongs to a specific HST class. Such reduced delays are motivated by the fact that the UE does not need to RX beam sweep in as many directions as a UE which may be handheld or portable and does not follow a constrained route of a rail track. At the same time, the reduced delays are also important and likely to be very necessary to ensure sufficient performance of the NR system in a high speed environment.

Since such enhancements are made feasible by the invention and are important, it is also beneficial that shorter minimum requirements for RRM measurement delays should be specified by RAN4 if this invention is adopted. Specifically, the invention allows smaller scaling factors or number of samples to be specified in various requirements, and the smaller scaling factor or reduced number of samples may be conditioned on, or a function of, the assistance information being provided to the UE.

Minimum requirements which could be reduced include, but are not limited to requirements in 3GPP TS 38.133 v16.5.0 for:
N1 in section 4.2.2.1, 4.2.2.2, 4.2.2.3 and 4.2.2.4 (idle mode reselection) and the corresponding requirements in 5.2.2.1, 5.2.2.2, 5.2.2.3 and 5.2.2.4 for RRC inactive mode reselection
Scaling factor N in requirements for radio link monitoring procedure in section 8.1.2 and 8.1.3.
Scaling factor N in requirements for link recovery procedures in section 8.5.2, 8.5.5 and 8.5.6
M_{pss/sss_sync_w/o_gaps} and M_{meas_period_w/o_gaps} in section 9.2.5
M_{pss/sss_sync_with_gaps} and M_{meas_period_with_gaps} in section 9.2.6
M_{pss/sss_sync_with_gaps} and M_{meas_period_with_gaps} in section 9.3.4
Number of samples for SFTD measurements in section 9.3.8 for FR2
Scaling factor N in L1-RSRP measurement requirements in section 9.5.4.1 and 9.5.4.2
Scaling factor N in L1-SINR measurement requirements in section 9.8.4.1, 9.8.4.2, and 9.8.4.3.

The systems, methods and techniques for restricting a set of received beams are described with specific examples, which are described below.

### Example of Adapting Beamsweeps in RRC Idle/Inactive States

One specific example of UE adapting number of beamsweeps (parameter N1) for different types of measurements in idle/inactive state when configured with a high speed indicator (e.g. highSpeedMeasFlagFR2) is shown in Table 3. Table 4 shows the values of legacy number of beamsweeps (parameter N1) which applies when the configured is NOT with any high speed indicator (e.g. not with highSpeedMeasFlagFR2). In Table 3, N1 is smaller than N1 in Table 4 since in the former case the UE performs only limited number of beamsweeps such as, for example, only beams along the rail track. This in turn reduces the measurement time and enhance the mobility performance in high speed scenario. The indicator in this example may also comprise information about the train layout as described above. The parameters, T_{detect,NR_Intra}, T_{measure,NR_Intra} and T_{evaluate,NR_Intra} are all measurement times for measurements on an intra-frequency cell. More specifically, T_{detect,NR_Intra}, T_{measure,NR_Intra}, and T_{evaluate,NR_Intra} correspond to cell detection time, measurement period for measurement on a cell, and time period to evaluate a cell for cell reselection, respectively.

TABLE 3
T_{detect, NR}_{_{—}}_{Intra}, T_{measure, NR}_{_{—}}_{Intra} and T_{evaluate, NR}_{_{—}}_{Intra} in FR2 for
UE configured with high speed indicator (e.g. highSpeedMeasFlagFR2)

| | Scaling | T_{detect, NR}_{_{—}}_{Intra} [s] | T_{measure, NR}_{_{—}}_{Intra} [s] | T_{evaluate, NR}_{_{—}}_{Intra} [s] |
|---|---|---|---|---|
| DRX cycle | Factor (N1) | (number of | (number of | (number of |
| length [s] | for FR2 | DRX cycles) | DRX cycles) | DRX cycles) |
| 0.32 | 4 | 11.52 × N1 × M2 | 1.28 × N1 × M2 | 5.12 × N1 × M2 |
| | | (36 × N1 × M2) | (4 × N1 × M2) | (16 × N1 × M2) |
| 0.64 | 3 | 17.92 × N1 | 1.28 × N1 | 5.12 × N1 |
| | | (28 × N1) | (2 × N1) | (8 × N1) |
| 1.28 | 2 | 32 × N1 | 1.28 × N1 | 6.4 × N1 |
| | | (25 × N1) | (1 × N1) | (5 × N1) |
| 2.56 | 1 | 58.88 × N1 | 2.56 × N1 | 7.68 × N1 |
| | | (23 × N1) | (1 × N1) | (3 × N1) |

Note 1:
M2 = 1.5 if SMTC periodicity of measured intra-frequency cell > 20 ms; otherwise M2 = 1.

TABLE 4
T_{detect, NR}_{_{—}}_{Intra}, T_{measure, NR}_{_{—}}_{Intra} and
T_{evaluate, NR}_{_{—}}_{Intra} in FR2 for UE NOT configured with
high speed indicator (e.g. not with highSpeedMeasFlagFR2)

| | Scaling | T_{detect, NR}_{_{—}}_{Intra} [s] | T_{measure, NR}_{_{—}}_{Intra} [s] | T_{evaluate, NR}_{_{—}}_{Intra} [s] |
|---|---|---|---|---|
| DRX cycle | Factor (N1) | (number of | (number of | (number of |
| length [s] | for FR2 | DRX cycles) | DRX cycles) | DRX cycles) |
| 0.32 | 8 | 11.52 × N1 × M2 | 1.28 × N1 × M2 | 5.12 × N1 × M2 |
| | | (36 × N1 × M2) | (4 × N1 × M2) | (16 × N1 × M2) |
| 0.64 | 5 | 17.92 × N1 | 1.28 × N1 | 5.12 × N1 |
| | | (28 × N1) | (2 × N1) | (8 × N1) |
| 1.28 | 4 | 32 × N1 | 1.28 × N1 | 6.4 × N1 |
| | | (25 × N1) | (1 × N1) | (5 × N1) |
| 2.56 | 3 | 58.88 × N1 | 2.56 × N1 | 7.68 × N1 |
| | | (23 × N1) | (1 × N1) | (3 × N1) |

Note 1:
M2 = 1.5 if SMTC periodicity of measured intra-frequency cell > 20 ms; otherwise M2 = 1.

### Example of Adapting Beamsweeps in RRC Connected State

Table 5 shows an example of a measurement period of measurement (e.g. RSRP, RSRQ, SINR etc) performed on signals of the cell.

TABLE 5
Measurement period for intra-frequency measurements

| without gaps (FR2)DRX cycle | T _{SSB}_{_{—}}ₘₑₐₛᵤᵣₑₘₑₙₜ_{_{—}}_{period}_{_{—}}ᵢₙₜᵣₐ |
|---|---|
| No DRX | max(400 ms, ceil(Mₘₑₐₛ_{_{—}}_{period}_{_{—}}_{w/o}_{_{—}}_{gaps} × Kₚ × |
| | K_{layer1}_{_{—}}ₘₑₐₛᵤᵣₑₘₑₙₜ) × SMTC period)^{Note 1} × CSSFᵢₙₜᵣₐ |
| DRX | max(400 ms, ceil(1.5 × Mₘₑₐₛ_{_{—}}_{period}_{_{—}}_{w/o}_{_{—}}_{gaps} × Kₚ × |
| cycle ≤ 320 ms | K_{layer1}_{_{—}}ₘₑₐₛᵤᵣₑₘₑₙₜ) × max(SMTC period, DRX cycle)) × |
| | CSSFᵢₙₜᵣₐ |
| DRX | ceil(Mₘₑₐₛ_{_{—}}_{period}_{_{—}}_{w/o}_{_{—}}_{gaps} × Kₚ × K_{layer1}_{_{—}}ₘₑₐₛᵤᵣₑₘₑₙₜ) × |
| cycle > 320 ms | DRX cycle × CSSFᵢₙₜᵣₐ |

NOTE 1:
If different SMTC periodicities are configured for different cells, the SMTC period in the requirement is the one used by the cell being identified

The measurement is a function of a scaling factor. Examples of functions are product, sum, ratio, ceiling, floor, etc. The scaling factor may also be called as scaling parameter, scaling multiplier, etc. The scaling factor depends on or correspond to one or more of: number of beam sweeps, number of measurement samples, number of measurement snapshots, number of samples for beam sweep, total number of samples during the measurements, etc., obtained for a measurement in connected state. For example, the values of one or more parameters used or involved in the measurement are scaled by the scaling factor (e.g. multiplied) to obtained the measurement result. A specific example of the scaling factor is a parameter, M_{meas_period_w/o_gaps}, whose value depends on the number of beam sweeps. For example, when the UE is configured with high speed indicator then M_{meas_period_w/o_gaps} is smaller compared the case when the UE is not configured with high speed indicator. The indicator in this example may also comprise information about the train layout as described above. This is further elaborated with specific examples below Similar examples are applicable for other types of measurement requirements such as, for example, measurement time for different types of intra-frequency, inter-frequency, or inter-RAT measurements. Examples of measurement time are cell detection delay, intra-frequency PSS/SSS acquisition delay, SSB index detection time period, L1-RSRP/L1-SINR measurement period, signal measurement period, etc. Examples of signal measurements are RSRP, RSRQ, SINR SS-RSRP, SS-RSRQ, SS-SINR, CSI-RS-RSRP, CSI-RS-RSRQ, CSI-RS-SINR, etc.

According to certain particular embodiments:
When the UE is configured with high speed indicator (e.g. highSpeedMeasFlagFR2), the value of this parameter can be expressed as follows:
   M_{meas_period_w/o_gaps}: For a UE supporting power class for high speed train scenario in FR2=6.
When the UE is NOT configured with high speed indicator (e.g. highSpeedMeasFlagFR2), the value of this parameter can be expressed as follows:
   M_{meas_period_w/o_gaps}: For a UE supporting power class for high speed train scenario in FR2=24.
   In a second example:
When the UE is configured with high speed indicator (e.g. highSpeedMeasFlagFR2) then the value of this parameter can be expressed as follows:
   M_{meas_period_w/o_gaps}: For a UE supporting power class 1, M_{meas_period_w/o_gaps}=10. For a UE supporting FR2 power class 2, M_{meas_period_w/o_gaps}=6. For a UE supporting power class 3, M_{meas_period_w/o_gaps}=6. For a UE supporting power class 4, M_{meas_period_w/o_gaps}=6.
When the UE is NOT configured with high speed indicator (e.g. highSpeedMeasFlagFR2) then the value of this parameter can be expressed as follows:
   M_{meas_period_w/o_gaps}: For a UE supporting power class 1, M_{meas_period_w/o_gaps}=40. For a UE supporting FR2 power class 2, M_{meas_period_w/o_gaps}=24. For a UE supporting power class 3, M_{meas_period_w/o_gaps}=24. For a UE supporting power class 4, M_{meas_period_w/o_gaps}=24.

Table 6 shows an example of an evaluation period of radio link monitoring (e.g. In-synch, Out-of-synch, etc.) performed on signals of the cell. The measurement is a function of the number of beam sweeps N. For example, when the UE is configured with high speed indicator, then N is smaller compared the case when the UE is not configured with high speed indicator. The indicator in this example may also comprise information about the train layout as described above. This is further elaborated with specific examples below. Similar examples are applicable for other types of evaluation requirements such as, for example, beam failure detection, candidate beam detection, etc.

In an example:
When the UE is configured with high speed indicator (e.g. highSpeedMeasFlagFR2), the value of this parameter can be expressed as follows:
   N=2
When the UE is NOT configured with high speed indicator (e.g. highSpeedMeasFlagFR2), the value of this parameter can be expressed as follows:
   N=8

TABLE 6
Evaluation period T_{Evaluate}_{_{—}}ₒᵤₜ_{_{—}}_{SSB} and T_{Evaluate}_{_{—}}ᵢₙ_{_{—}}_{SSB} for FR2

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | Max(200, Ceil(10 × | Max(100, Ceil(5 × |
| | P × N) × T_{SSB}) | P × N) × T_{SSB}) |
| DRX | Max(200, Ceil(15 × | Max(100, Ceil(7.5 × |
| cycle ≤ 320 ms | P × N) × | P × N) × |
| | Max(T_{DRX}, T_{SSB})) | Max(T_{DRX}, T_{SSB})) |
| DRX | Ceil(10 × P × | Ceil(5 × P × |
| cycle > 320 ms | N) × T_{DRX} | N) × T_{DRX} |

NOTE:
T_{SSB} is the periodicity of the SSB configured for RLM. T_{DRX} is the DRX cycle length.

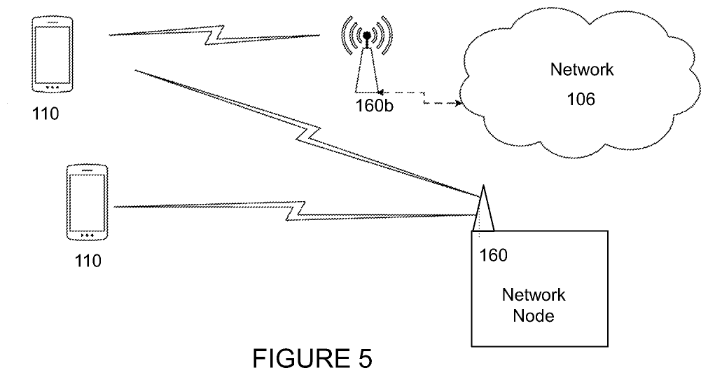

FIG. 5 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 5. For simplicity, the wireless network of FIG. 5 only depicts network 106, network nodes 160 and 160b, and wireless devices 110. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

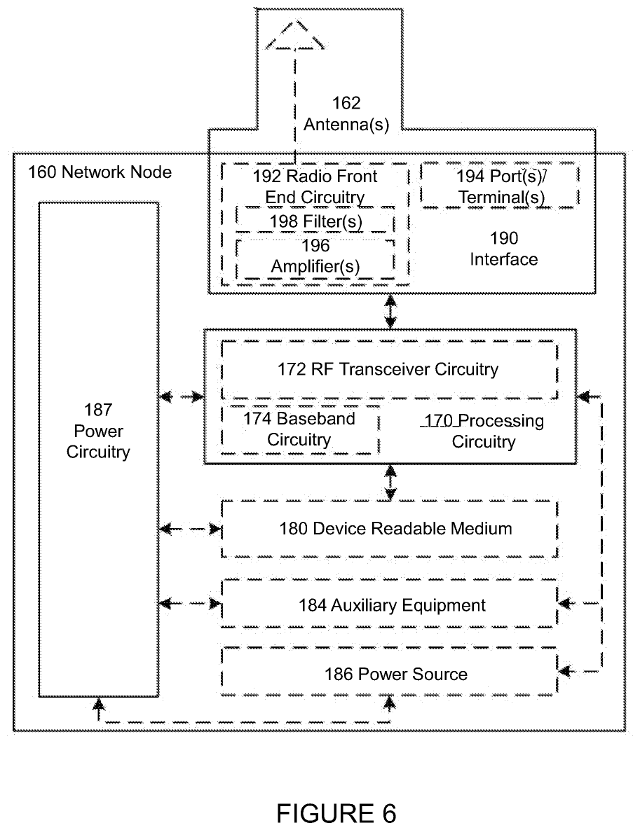

FIG. 6 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BS s, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 160 includes processing circuitry 170, device readable medium 180, interface 190, auxiliary equipment 184, power source 186, power circuitry 187, and antenna 162. Although network node 160 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 6 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

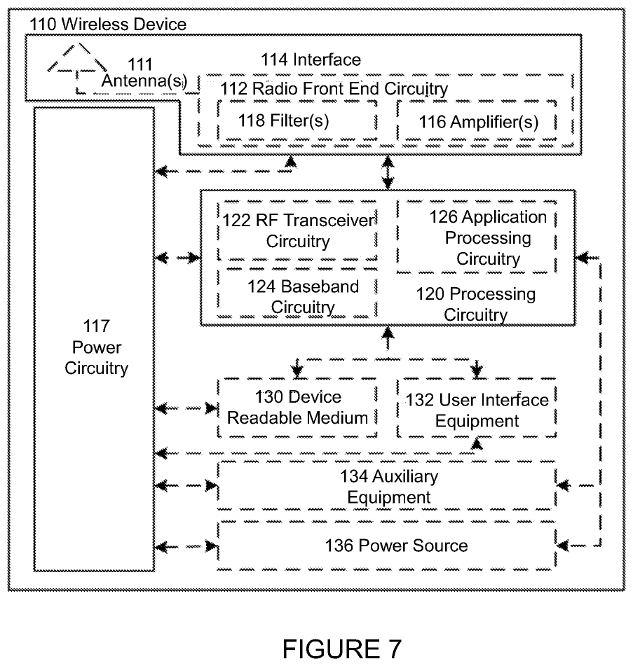

FIG. 7 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. In further examples, the wireless device might be vehicle-mounted. For instance, the vehicle might be a train, or more particularly a train carriage (e.g. for a high-speed train) as described in the above embodiments. In such cases, the wireless device can be mounted to a suitable area of the train, such as the roof. In this scenario, the network node 160 can be a trackside network node, as described above. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

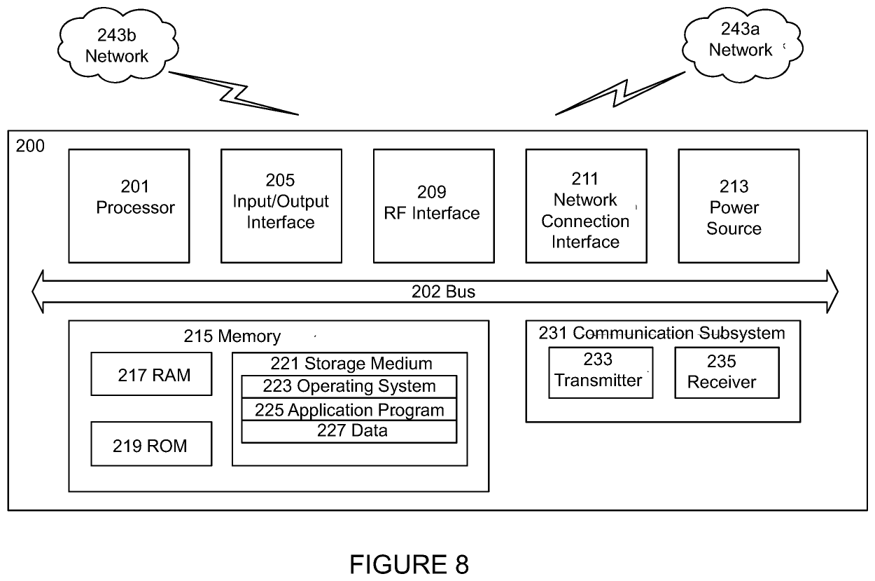

FIG. 8 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). The UE might be vehicle-mounted, as described above. UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 6, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 8 is a UE, the components discussed herein are equally applicable to a wireless device, and vice-versa.

In FIG. 8, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 8, or only a subset of the components. The level of integration between the components may vary from one UE to another UE. Further, certain UEs may contain multiple instances of a component, such as multiple processors, memories, transceivers, transmitters, receivers, etc.

In FIG. 8, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 8, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 8, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

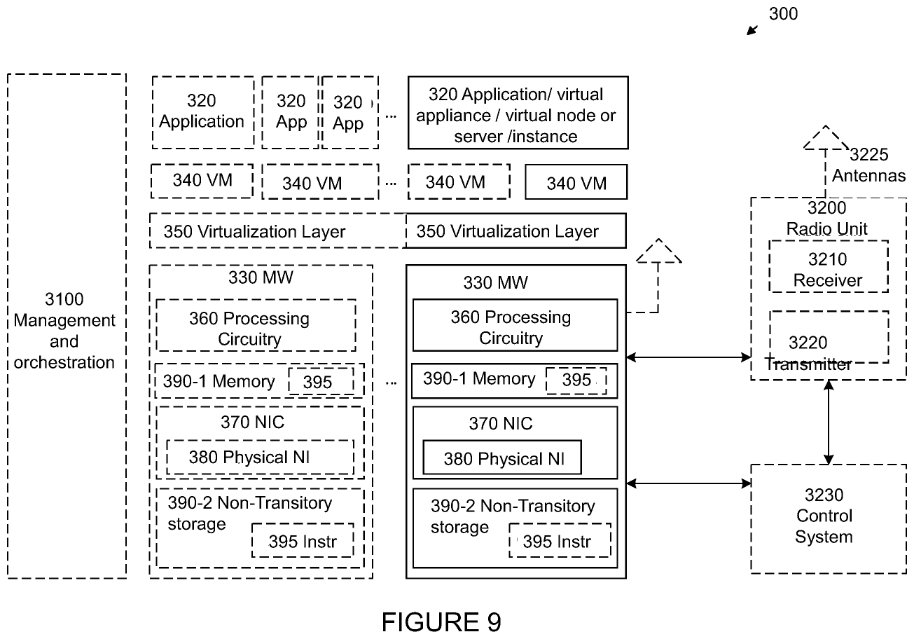

FIG. 9 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 9, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 9.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

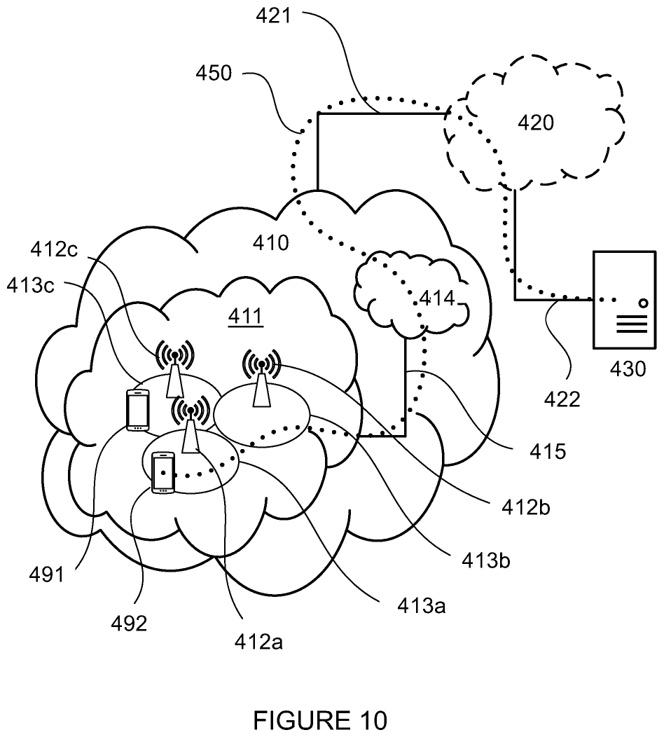

FIG. 10 illustrates a telecommunication network connected via an intermediate network to a host computer in accordance with some embodiments.

With reference to FIG. 10, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NB s, eNBs, gNBs or other types of wireless access points, each defining a corresponding coverage area 413a, 413b, 413c. Each base station 412a, 412b, 412c is connectable to core network 414 over a wired or wireless connection 415. One or more of the base stations may be located trackside, as discussed in embodiments above. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412. One or more of the UEs can be vehicle mounted, e.g. train-mounted, as described in embodiments above.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 10 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

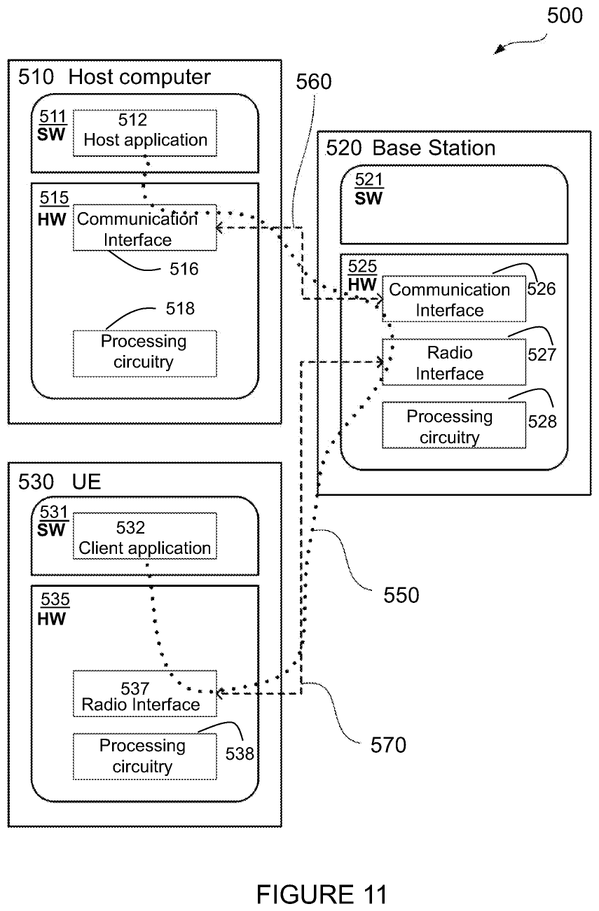

FIG. 11 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 11. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 11) served by base station 520. Communication interface 526 may be configured to facilitate connection 560 to host computer 510. Connection 560 may be direct or it may pass through a core network (not shown in FIG. 11) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 11 may be similar or identical to host computer 430, one of base stations 412a, 412b, 412c and one of UEs 491, 492 of FIG. 10, respectively. This is to say, the inner workings of these entities may be as shown in FIG. 11 and independently, the surrounding network topology may be that of FIG. 10.

In FIG. 11, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

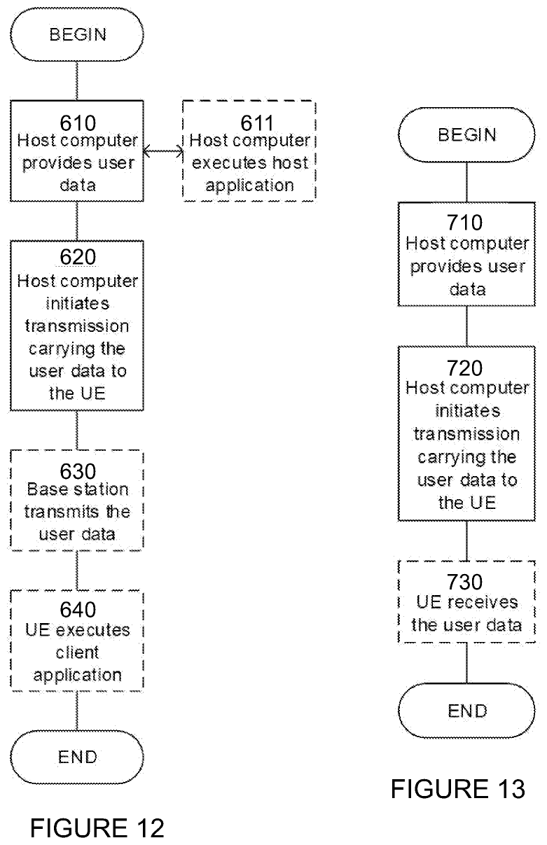

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

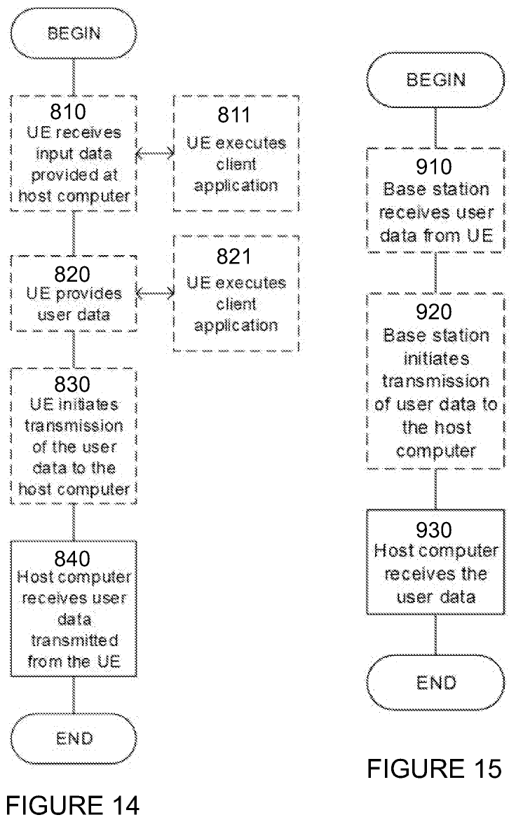

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

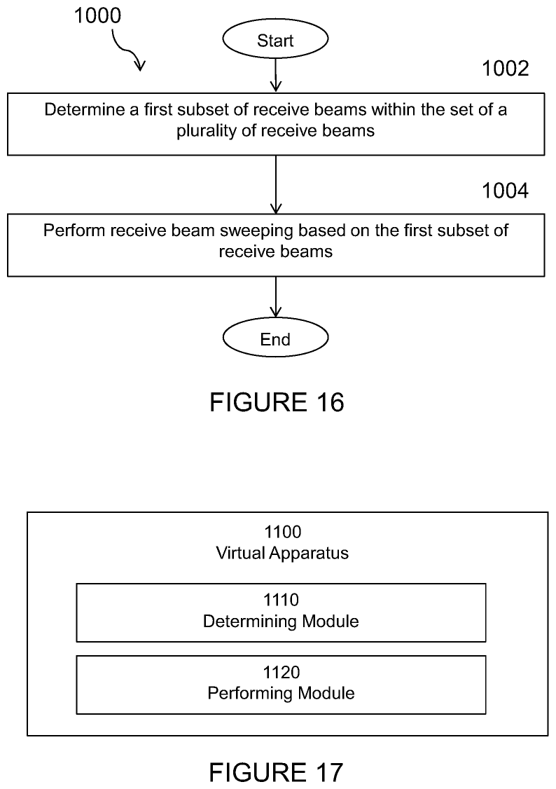

FIG. 16 depicts a method 1000 by a wireless device 110 operable to perform receive beam sweeping over a set of a plurality of receive beams, according to certain embodiments. The method begins at step 1002 when the wireless device determines a first subset of receive beams within the set of a plurality of receive beams. At step 1004, the wireless device performs receive beam sweeping based on the first subset of receive beams.

In a particular embodiment, the performing step comprises performing at least one measurement on the first subset of receive beams.

In a particular embodiment, the first subset of receive beams comprises fewer beams than the set of the plurality of receive beams.

In a particular embodiment, the first subset of receive beams is determined based on a receive beam that is currently or previously used for a Radio Resource Management (RRM) operation.

In a particular embodiment, the first subset of receive beams is determined based on a spatial arrangement of the plurality of receive beams.

In a particular embodiment, the first subset of receive beams is determined based on at least one of: a position of the wireless device relative to a vehicle on which the wireless device is mounted; and a route of the vehicle on which the wireless device is mounted.

In a particular embodiment, the first subset of receive beams is determined for a first synchronization signal burst (SSB) based on an identification of beams measured for a second SSB prior to receiving the first SSB.

In a particular embodiment, the first subset of receive beams is associated with a first Remote Radio Head (RRH).

In a further particular embodiment, the wireless device determines a second subset of receive beams within the set of a plurality of receive beams that is associated with a second RRH and performs receive beam sweeping for the second subset of receive beams.

In a further particular embodiment, the first and second RRHs are associated with different physical cell identifiers.

In a particular embodiment, the number of beams within the first subset of receive beams is fixed.

In a particular embodiment, the wireless device determines the number of beams within the first subset of receive beams based on at least one of: a route or path of the wireless device; a speed of the wireless device; a trajectory of the wireless device; a distance of a RRH from the wireless device; a geographical arrangement of a train track on which the wireless device is moving; and train deployment and/or train layout information.

In a particular embodiment, the wireless device receives, from a network node, assistance information, and the first subset of receive beams is determined based on the assistance information.

In a further particular embodiment, the assistance information comprises at least one of: an estimated position of the wireless device; an actual position of the wireless device; an estimated speed of the wireless device; an actual speed of the wireless device; geographical information associated with a network deployment; a position of an RRH antenna; an actual or expected route of a vehicle on which the wireless device is mounted; a distance of a RRH from the wireless device; a distance of a RRH from a route of the vehicle on which the wireless device is mounted; and train deployment and/or train layout information.

In a further particular embodiment, the assistance information comprises at least one of: Dmin, Ds, Drrh_h, and a geographical coordinate of a location of a RRH, where Dmin is a perpendicular distance between the RRH and track on which the vehicle travels; Ds is the distance between adjacent RRH and Drrh_h is the vertical height of the RRH above the ground.

In a further particular embodiment, the wireless device determines, based on the assistance information, a location of a RRH relative to the wireless device.

In a further particular embodiment, the assistance information comprises at least one angle of a position of the wireless device relative to a RRH.

In a further particular embodiment, the assistance information comprises a distance of a RRH from an actual or expected route of the wireless device and/or a vehicle associated with the wireless device.

In a further particular embodiment, the assistance information comprises an indication that the wireless device is associated with a high speed train.

In a further particular embodiment, the wireless device determines, based on the indication, that the wireless device is traveling at a speed that is greater than a threshold speed.

In a further particular embodiment, the wireless device determines, based on the indication, that the wireless device is traveling at a speed that is within a range of speeds that are associated with the high speed train.

In a further particular embodiment, the wireless device determines the first subset of receive beams in response to receiving the indication the wireless device is associated with the high speed train.

In a further particular embodiment, the assistance information comprises an indication of a Doppler frequency and/or Doppler frequency range associated with the wireless device.

In a further particular embodiment, the wireless device transmits, to the network node, an indication of a High Speed Train (HST) class associated with a vehicle associated with the wireless device.

In a further particular embodiment, the assistance information is based on the HST class associated with the wireless device.

In a particular embodiment, the wireless device is in an idle or inactive state, and a number of beams in the subset of receive beams is determined at least in part based on the wireless device being in the idle or inactive state.

In a particular embodiment, the wireless device is in a connected state, and a number of beams in the subset of receive beams is determined at least in part based on the wireless device being in the connected state.

In a particular embodiment, performing the receive beam sweeping based on the subset of receive beams comprises adapting a Radio Resource Management (RRM) operation based on the first subset of receive beams.

In a further particular embodiment, adapting the RRM operation comprises performing the receive beam sweeping over a reduced number of beams as compared to a reference number of beams.

In a further particular embodiment, the reference number of beams is eight, and wherein the reduced number of beams sweeps is less than eight.

In a further particular embodiment, the reference number of beams corresponds to the set of the plurality of beams.

In a further particular embodiment, when the wireless device receives assistance information upon which the first subset of receive beams is determined, the reduced number of beams corresponds to the number of beams over which receive beam sweeping is performed when the assistance information is received, and the reference number of beams corresponds to number of beams over which receive beam sweeping is performed when no assistance information is received by the wireless device.

In a further particular embodiment, adapting the RRM operation comprises performing a measurement during an adapted measurement time (Ta), which is shorter than a reference measurement time (Tr) where Tm<Tr.

In a further particular embodiment, performing the measurement during the reference measurement time comprises performing the measurement when the number of beams over which receive beam sweeping is to be performed corresponds to the reference number of beams.

In a further particular embodiment, the wireless device performs the measurement during the adapted measurement time when the assistance information is received and performs the measurement during the reference measurement time when no assistance information is received by the wireless device.

In a particular embodiment, the wireless device comprises a user equipment (UE).

In a further particular embodiment, the UE is mounted on a train.

FIG. 16 illustrates a schematic block diagram of a virtual apparatus 1100 in a wireless network (for example, the wireless network shown in FIG. 5). The apparatus may be implemented in a wireless device or network node (e.g., wireless device 110 or network node 160 shown in FIG. 5). Apparatus 1100 is operable to carry out the example method described with reference to FIG. 15 and possibly any other processes or methods disclosed herein. It is also to be understood that the method of FIG. 15 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining module 1110, performing module 1120, and any other suitable units of apparatus 1100 to perform corresponding functions according one or more embodiments of the present disclosure.

According to certain embodiments, determining module 1110 may perform certain of the determining functions of the apparatus 1100. For example, determining module 1110 may determine a first subset of receive beams within the set of a plurality of receive beams.

According to certain embodiments, performing module 1120 may perform certain of the performing functions of the apparatus 1100. For example, performing module 1120 may perform receive beam sweeping based on the first subset of receive beams.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

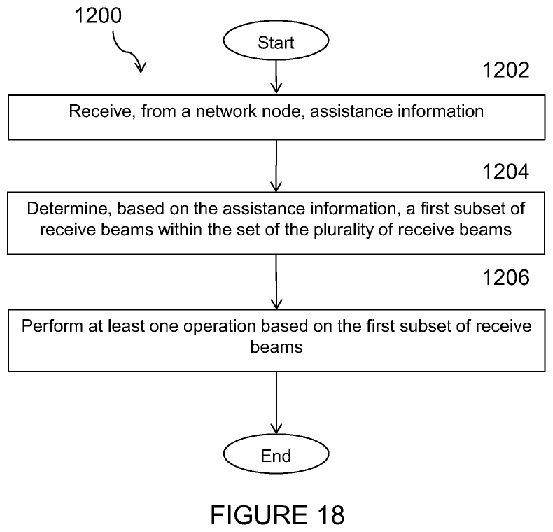

FIG. 18 illustrates another example method 1200 by a wireless device 110 operable to perform receive beam sweeping over a set of a plurality of receive beams, according to certain embodiments. The method begins at step 1202 when the wireless device 110 receives assistance information from a network node 160. At step 1204, the wireless device 110 determines, based on the assistance information, a first subset of receive beams within the set of the plurality of receive beams. At step 1206, the wireless device 110 performs at least one operation based on the first subset of receive beams.

In a particular embodiment, performing the at least one operation includes performing at least one measurement based on the first subset of receive beams.

In a particular embodiment, the first subset of receive beams comprises fewer beams than the set of the plurality of receive beams.

In a particular embodiment, the first subset of receive beams comprises all of the set of the plurality of receive beams.

In a particular embodiment, the assistance information includes at least one of: an estimated position of the wireless device; an actual position of the wireless device; an estimated speed of the wireless device; an actual speed of the wireless device; geographical information associated with a network deployment; a position of an antenna of at least one network node; an actual or expected route of a vehicle on which the wireless device is mounted; a distance of at least one network node from the wireless device; a distance of at least one network node from a route of the vehicle on which the wireless device is mounted; and vehicle deployment and/or vehicle layout information.

In a particular embodiment, the assistance information comprises at least one of: Dmin, Ds, Drrh_h, and a geographical coordinate of a location of at least one network node, where Dmin is a perpendicular distance between the at least one network node and track on which the vehicle travels; Ds is the distance between adjacent at least one network node and Drrh_h is the vertical height of the at least one network node above the ground.

In a particular embodiment, the wireless device 110 determines, based on the assistance information, a location of at least one network node relative to the wireless device.

In a particular embodiment, the assistance information comprises at least one angle of a position of the wireless device relative to at least one network node.

In a particular embodiment, the assistance information comprises a distance of at least one network node from an actual or expected route of the wireless device and/or a vehicle associated with the wireless device.

In a particular embodiment, the assistance information comprises an indication that the wireless device is traveling at a speed that is greater than a threshold speed or within a range of speeds that are associated with a high speed vehicle.

In a particular embodiment, the wireless device 110 determines the first subset of receive beams in response to receiving the indication the wireless device is traveling at a speed that is greater than a threshold speed or is travelling at a speed that is within a range of speeds that are associated with the high speed vehicle. In a particular embodiment, performing the at least one operation comprises adapting a RRM operation based on the first subset of receive beams.

In a further particular embodiment, adapting the RRM operation comprises performing the receive beam sweeping over a reduced number of beams as compared to a reference number of beams.

In a particular embodiment, the reduced number of beams corresponds to the number of beams over which receive beam sweeping is performed when the assistance information is received, and the reference number of beams corresponds to number of beams over which receive beam sweeping is performed if no assistance information was received by the wireless device.

In a particular embodiment, the wireless device comprises a UE mounted on a vehicle.

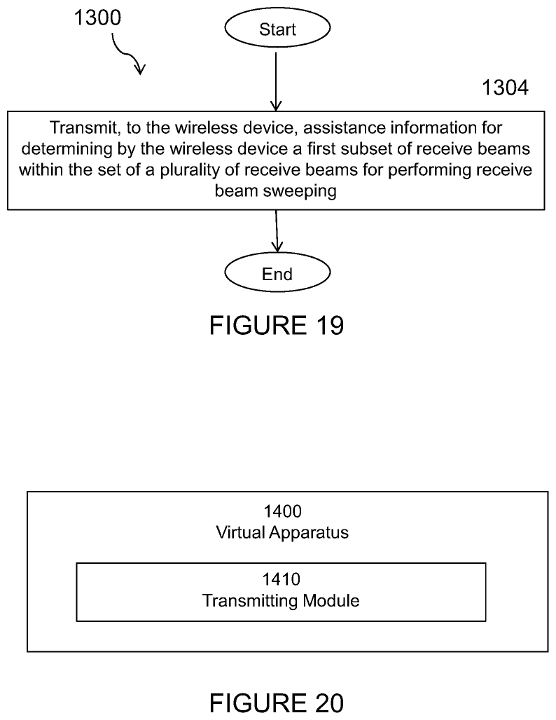

FIG. 19 depicts a method 1300 by a network node 160 operable to assist a wireless device 110 in performing receive beam sweeping over a set of a plurality of receive beams, according to certain embodiments. At step 1302, the network node 160 transmits, to the wireless device 110, assistance information for determining by the wireless device 110 a first subset of receive beams within the set of a plurality of receive beams for performing receive beam sweeping.

In a particular embodiment, the first subset of receive beams comprises fewer beams than the set of the plurality of beams.

In a particular embodiment, the network node configures the wireless device to determine the first subset of receive beams within the set of the plurality of receive beams based on the assistance information.

In a particular embodiment, the network node configures the wireless device to determine the first subset of receive beams based on a receive beam that is currently or previously used for a Radio Resource Management (RRM) operation.

In a particular embodiment, the network node configures the wireless device to determine the first subset of receive beams based on a spatial arrangement of the plurality of receive beams.

In a particular embodiment, the network node configures the wireless device to determine the first subset of receive beams based on at least one of: a position of the wireless device relative to a vehicle on which the wireless device is mounted; and a route of the vehicle on which the wireless device is mounted.

In a particular embodiment, the network node configures the wireless device to determine the first subset of receive beams for a first synchronization signal burst (SSB) based on an identification of beams measured for a second SSB prior to receiving the first SSB.

In a particular embodiment, the first subset of receive beams is associated with a first Remote Radio Head (RRH).

In a further particular embodiment, the network node configures the wireless device to: determine a second subset of receive beams within the set of a plurality of receive beams that is associated with a second RRH; and perform receive beam sweeping for the second subset of receive beams.

In a further particular embodiment, the first and second RRHs are associated with different physical cell identifiers.

In a particular embodiment, the number of beams within the first subset of receive beams is fixed.

In a particular embodiment, the network node configures the wireless device to determine the number of beams within the first subset of receive beams based on at least one of: a route or path of the wireless device; a speed of the wireless device; a trajectory of the wireless device; a distance of a RRH from the wireless device; a geographical arrangement of a train track on which the wireless device is moving; and train deployment and/or train layout information.

In a particular embodiment, the assistance information comprises at least one of: an estimated position of the wireless device; an actual position of the wireless device; an estimated speed of the wireless device; an actual speed of the wireless device; geographical information associated with a network deployment; a position of an antenna of an RRH or other network node; an actual or expected route of a vehicle on which the wireless device is mounted; a distance of an RRH or other network node from the wireless device; a distance of an RRH or other network node from a route of the vehicle on which the wireless device is mounted; and vehicle/train deployment and/or vehicle/train layout information.

In a particular embodiment, the assistance information comprises at least one of: Dmin, Ds, Drrh_h, and a geographical coordinate of a location of a RRH or other network node, where Dmin is a perpendicular distance between the RRH or other network node and track on which the vehicle travels; Ds is the distance between adjacent RRH or network nodes and Drrh_h is the vertical height of the RRH or other network node above the ground.

In a particular embodiment, the network node configures the wireless device to determine, based on the assistance information, a location of a RRH or other network node relative to the wireless device.

In a particular embodiment, the assistance information comprises at least one angle of a position of the wireless device relative to a RRH or other network node.

In a particular embodiment, the assistance information comprises a distance of a RRH or other network node from an actual or expected route of the wireless device and/or a vehicle associated with the wireless device.

In a particular embodiment, the assistance information comprises an indication that the wireless device is associated with a high speed train.

In a particular embodiment, the network node configures the wireless device to determine based on the indication, that the wireless device is traveling at a speed that is greater than a threshold speed.

In a further particular embodiment, the network node configures the wireless device to determine based on the indication, that the wireless device is traveling at a speed that is within a range of speeds that are associated with the high speed train.

In a further particular embodiment, the network node determines the first subset of receive beams in response to receiving the indication the wireless device is associated with the high speed train.

In a particular embodiment, the assistance information comprises an indication of a Doppler frequency and/or Doppler frequency range associated with the wireless device.

In a particular embodiment, the network node receives, from the wireless device, an indication of a High Speed Train (HST) class associated with a vehicle associated with the wireless device.

In a particular embodiment, the network node determines the assistance information based on the HST class associated with the wireless device.

In a particular embodiment, the wireless device is in an idle or inactive state, and the network node configures the wireless device to determine a number of beams in the subset of receive beams based at least in part based on the wireless device being in the idle or inactive state.

In a particular embodiment, the wireless device is in a connected state, and the network node configures the wireless device to determine a number of beams in the subset of receive beams based at least in part based on the wireless device being in the connected state.

In a particular embodiment, the network node configures the wireless device to adapt a Radio Resource Management (RRM) operation based on the first subset of receive beams.

In a particular embodiment, configuring the wireless device to adapt the RRM operation comprises configuring the wireless device to perform the receive beam sweeping over a reduced number of beams as compared to a reference number of beams.

In a further particular embodiment, the reference number of beams is eight, and wherein the reduced number of receive beams is less than eight.

In a further particular embodiment, the reference number of beams corresponds to the set of the plurality of beams.

In a further particular embodiment, the reduced number of beams corresponds to the number of beams over which receive beam sweeping is performed when the assistance information is received, and the reference number of beams corresponds to number of beams over which receive beam sweeping is performed when no assistance information is received by the wireless device.

In a further particular embodiment, configuring the wireless device to adapt the RRM operation comprises configuring the wireless device to perform a measurement during an adapted measurement time (Ta), which is shorter than a reference measurement time (Tr) where Tm<Tr.

In a further particular embodiment, configuring the wireless device to perform the measurement during the reference measurement time comprises configuring the wireless device to perform the measurement when the number of beams over which receive beam sweeping is to be performed corresponds to the reference number of beams.

In a particular embodiment, the network node configures the wireless device to: perform the measurement during the adapted measurement time when the assistance information is received, and perform the measurement during the reference measurement time when no assistance information is received by the wireless device.

In a particular embodiment, the wireless device comprises a user equipment (UE).

In a further particular embodiment, the UE is mounted on a train.

In a particular embodiment, the first subset of receive beams comprises all of the set of the plurality of receive beams.

In a particular embodiment, the assistance information comprises an indication that the wireless device is traveling at a speed that is greater than a threshold speed or within a range of speeds that are associated with a high speed vehicle.

In a particular embodiment, the network node determines the first subset of receive beams in response to receiving the indication the wireless device is traveling at a speed that is greater than a threshold speed or is travelling at a speed that is within a range of speeds that are associated with the high speed vehicle.

In a particular embodiment, the network node configures the wireless device to perform the receive beam sweeping over a reduced number of beams as compared to a reference number of beams, which may correspond to the set of the plurality of beams.

FIG. 18 illustrates a schematic block diagram of a virtual apparatus 1400 in a wireless network (for example, the wireless network shown in FIG. 5). The apparatus may be implemented in a wireless device or network node (e.g., wireless device 110 or network node 160 shown in FIG. 5). Apparatus 1400 is operable to carry out the example method described with reference to FIG. 17 and possibly any other processes or methods disclosed herein. It is also to be understood that the method of FIG. 17 is not necessarily carried out solely by apparatus 1400. At least some operations of the method can be performed by one or more other entities.

Virtual Apparatus 1400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1410 and any other suitable units of apparatus 1400 to perform corresponding functions according one or more embodiments of the present disclosure.

According to certain embodiments, transmitting module 1410 may perform certain of the transmitting functions of the apparatus 1400. For example, transmitting module 1410 may transmit, to the wireless device, assistance information for determining by the wireless device a first subset of receive beams within the set of a plurality of receive beams for performing receive beam sweeping.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### EXAMPLE EMBODIMENTS

### Group A Example Embodiments

Example Embodiment A1. A method by a wireless device operable to perform receive beam sweeping over a set of a plurality of receive beams, the method comprising: determining a first subset of receive beams within the set of a plurality of receive beams; and performing receive beam sweeping based on the first subset of receive beams.

Example Embodiment A2. The method of Example Embodiment A1, wherein the performing step comprises performing at least one measurement on the first subset of receive beams.

Example Embodiment A3. The method of any one of Example Embodiments A1 to A2, wherein the first subset of receive beams comprises fewer beams than the set of the plurality of receive beams.

Example Embodiment A4. The method of any one of Example Embodiments A1 to A3, wherein the first subset of receive beams is determined based on a receive beam that is currently or previously used for a Radio Resource Management (RRM) operation.

Example Embodiment A5. The method of any one of Example Embodiments A1 to A4, wherein the first subset of receive beams is determined based on a spatial arrangement of the plurality of receive beams.

Example Embodiment A6. The method of any one of Example Embodiments A1 to A5, wherein the first subset of receive beams is determined based on at least one of: a position of the wireless device relative to a vehicle on which the wireless device is mounted; and a route of the vehicle on which the wireless device is mounted.

Example Embodiment A7. The method of any one of Example Embodiments A1 to A6, wherein the first subset of receive beams is determined for a first synchronization signal burst (SSB) based on an identification of beams measured for a second SSB prior to receiving the first SSB.

Example Embodiment A8. The method of any one of Embodiments A1 to A7, wherein the first subset of receive beams is associated with a first Remote Radio Head (RRH).

Example Embodiment A9. The method of any one of Example Embodiment A8, further comprising: determining a second subset of receive beams within the set of a plurality of receive beams that is associated with a second RRH; and performing receive beam sweeping for the second subset of receive beams.

Example Embodiment A10. The method of Example Embodiment A9, wherein the first and second RRHs are associated with different physical cell identifiers.

Example Embodiment A11. The method of any one of Example Embodiments A1 to A10, wherein the number of beams within the first subset of receive beams is fixed.

Example Embodiment A12. The method of any one of Example Embodiments A1 to A10, further comprising determining the number of beams within the first subset of receive beams based on at least one of: a route or path of the wireless device; a speed of the wireless device; a trajectory of the wireless device; a distance of a RRH from the wireless device; a geographical arrangement of a train track on which the wireless device is moving; and train deployment and/or train layout information.

Example Embodiment A13. The method of any one of Example Embodiments A1 to A12, further comprising receiving, from a network node, assistance information, and wherein the first subset of receive beams is determined based on the assistance information.

Example Embodiment A14. The method of Example Embodiment A13, wherein the assistance information comprises at least one of: an estimated position of the wireless device; an actual position of the wireless device; an estimated speed of the wireless device; an actual speed of the wireless device; geographical information associated with a network deployment; a position of an RRH antenna; an actual or expected route of a vehicle on which the wireless device is mounted; a distance of a RRH from the wireless device; a distance of a RRH from a route of the vehicle on which the wireless device is mounted; and train deployment and/or train layout information.

Example Embodiment A15. The method of any one of Example Embodiments A13 to A14, wherein the assistance information comprises at least one of: Dmin, Ds, Drrh_h, and a geographical coordinate of a location of a RRH, where Dmin is a perpendicular distance between the RRH and track on which the vehicle travels; Ds is the distance between adjacent RRH and Drrh_h is the vertical height of the RRH above the ground.

Example Embodiment A16. The method of any one of Example Embodiments A13 to A15, further comprising determining, based on the assistance information, a location of a RRH relative to the wireless device.

Example Embodiment A17. The method of any one of Example Embodiments A13 to A16, wherein the assistance information comprises at least one angle of a position of the wireless device relative to a RRH.

Example Embodiment A18. The method of any one of Example Embodiments A13 to A17, wherein the assistance information comprises a distance of a RRH from an actual or expected route of the wireless device and/or a vehicle associated with the wireless device.

Example Embodiment A19. The method of any one of Example Embodiments A13 to A18, wherein the assistance information comprises an indication that the wireless device is associated with a high speed train.

Example Embodiment A20. The method of Example Embodiment A19, further comprising determining, based on the indication, that the wireless device is traveling at a speed that is greater than a threshold speed.

Example Embodiment A21. The method of Example Embodiment A19, further comprising determining, based on the indication, that the wireless device is traveling at a speed that is within a range of speeds that are associated with the high speed train.

Example Embodiment A22. The method of any of Example Embodiments A19 to A21, wherein the method comprises determining the first subset of receive beams in response to receiving the indication the wireless device is associated with the high speed train.

Example Embodiment A23. The method of any one of Example Embodiments A13 to A22, wherein the assistance information comprises an indication of a Doppler frequency and/or Doppler frequency range associated with the wireless device.

Example Embodiment A24. The method of any one of Example Embodiments A13 to A23, further comprising transmitting, to the network node, an indication of a High Speed Train (HST) class associated with a vehicle associated with the wireless device.

Example Embodiment A25. The method of Example Embodiment A24, wherein the assistance information is based on the HST class associated with the wireless device.

Example Embodiment A26. The method of any one of Example Embodiments A1 to A25, wherein the wireless device is in an idle or inactive state, and wherein a number of beams in the subset of receive beams is determined at least in part based on the wireless device being in the idle or inactive state.

Example Embodiment A27. The method of any one of Example Embodiments A1 to A25, wherein the wireless device is in a connected state, and wherein a number of beams in the subset of receive beams is determined at least in part based on the wireless device being in the connected state.

Example Embodiment A28. The method of any one of Example Embodiments A1 to A27, wherein performing the receive beam sweeping based on the subset of receive beams comprises adapting a Radio Resource Management (RRM) operation based on the first subset of receive beams.

Example Embodiment A29. The method of Example Embodiment A28, wherein adapting the RRM operation comprises performing the receive beam sweeping over a reduced number of beams as compared to a reference number of beams.

Example Embodiment A30. The method of Example Embodiment A29, wherein the reference number of beams is eight, and wherein the reduced number of beams sweeps is less than eight.

Example Embodiment A31. The method of Example Embodiment A29 or A30, wherein the reference number of beams corresponds to the set of the plurality of beams.

Example Embodiment A32. The method of any of Example Embodiments A29 to A31 when dependent on Example Embodiment A13, wherein the reduced number of beams corresponds to the number of beams over which receive beam sweeping is performed when the assistance information is received, and the reference number of beams corresponds to number of beams over which receive beam sweeping is performed when no assistance information is received by the wireless device.

Example Embodiment A33. The method of Example Embodiment A28-A32, wherein adapting the RRM operation comprises performing a measurement during an adapted measurement time (Ta), which is shorter than a reference measurement time (Tr) where Tm<Tr.

Example Embodiment A34. The method of Example Embodiment A33, wherein performing the measurement during the reference measurement time comprises performing the measurement when the number of beams over which receive beam sweeping is to be performed corresponds to the reference number of beams.

Example Embodiment A35. The method of Example Embodiment A33, further comprising performing the measurement during the adapted measurement time when the assistance information is received, and performing the measurement during the reference measurement time when no assistance information is received by the wireless device.

Example Embodiment A36. The method of any one of Example Embodiments A1 to A35, wherein the wireless device comprises a user equipment (UE).

Example Embodiment A37. The method of Example Embodiment A36, wherein the UE is mounted on a train.

Example Embodiment A38. A wireless device comprising processing circuitry configured to perform any of the methods of Example Embodiments A1 to A37.

Example Embodiment A39. A computer program comprising instructions which when executed on a computer perform any of the methods of Example Embodiments A1 to A37.

Example Embodiment A40. A computer program product comprising computer program, the computer program comprising instructions which when executed on a computer perform any of the methods of Example Embodiments A1 to A37.

Example Embodiment A41. A non-transitory computer readable medium storing instructions which when executed by a computer perform any of the methods of Example Embodiments A1 to A37.

### Group B Embodiments

Example Embodiment B1. A method by a network node operable to assist a wireless device in performing receive beam sweeping over a set of a plurality of receive beams, the method comprising: transmitting, to the wireless device, assistance information for determining by the wireless device a first subset of receive beams within the set of a plurality of receive beams for performing receive beam sweeping.

Example Embodiment B2. The method of Example Embodiment B1, wherein the first subset of receive beams comprises fewer beams than the set of the plurality of beams.

Example Embodiment B3. The method of any one of Example Embodiments B1 to B2, further comprising configuring the wireless device to determine the first subset of receive beams within the set of the plurality of receive beams based on the assistance information.

Example Embodiment B4. The method of any one of Example Embodiments B1 to B3, further comprising configuring the wireless device to determine the first subset of receive beams based on a receive beam that is currently or previously used for a Radio Resource Management (RRM) operation.

Example Embodiment B5. The method of any one of Example Embodiments B1 to B4, further comprising configuring the wireless device to determine the first subset of receive beams based on a spatial arrangement of the plurality of receive beams.

Example Embodiment B6. The method of any one of Example Embodiments B1 to B5, further comprising configuring the wireless device to determine the first subset of receive beams based on at least one of: a position of the wireless device relative to a vehicle on which the wireless device is mounted; and a route of the vehicle on which the wireless device is mounted.

Example Embodiment B7. The method of any one of Example Embodiments B1 to B6, further comprising configuring the wireless device to determine the first subset of receive beams for a first synchronization signal burst (SSB) based on an identification of beams measured for a second SSB prior to receiving the first SSB.

Example Embodiment B8. The method of any one of Example Embodiments B1 to B7, wherein the first subset of receive beams is associated with a first Remote Radio Head (RRH).

Example Embodiment B9. The method of Example Embodiment B8, further comprising configuring the wireless device to: determine a second subset of receive beams within the set of a plurality of receive beams that is associated with a second RRH; and perform receive beam sweeping for the second subset of receive beams.

Example Embodiment B10. The method of Example Embodiment B9, wherein the first and second RRHs are associated with different physical cell identifiers.

Example Embodiment B11. The method of any one of Example Embodiments B1 to B10, wherein the number of beams within the first subset of receive beams is fixed.

Example Embodiment B12. The method of any one of Example Embodiments B1 to B10, further comprising configuring the wireless device to determine the number of beams within the first subset of receive beams based on at least one of: a route or path of the wireless device; a speed of the wireless device; a trajectory of the wireless device; a distance of a RRH from the wireless device; a geographical arrangement of a train track on which the wireless device is moving; and train deployment and/or train layout information.

Example Embodiment B13. The method of any one of Example Embodiments B1 to B12, wherein the assistance information comprises at least one of: an estimated position of the wireless device; an actual position of the wireless device; an estimated speed of the wireless device; an actual speed of the wireless device; geographical information associated with a network deployment; a position of an RRH antenna; an actual or expected route of a vehicle on which the wireless device is mounted; a distance of a RRH from the wireless device; a distance of a RRH from a route of the vehicle on which the wireless device is mounted; and train deployment and/or train layout information.

Example Embodiment B14. The method of any one of Example Embodiments B1 to B13, wherein the assistance information comprises at least one of: Dmin, Ds, Drrh_h, and a geographical coordinate of a location of a RRH, where Dmin is a perpendicular distance between the RRH and track on which the vehicle travels; Ds is the distance between adjacent RRH and Drrh_h is the vertical height of the RRH above the ground.

Example Embodiment B15. The method of any one of Example Embodiments B13 to B14, further comprising configuring the wireless device to determine, based on the assistance information, a location of a RRH relative to the wireless device.

Example Embodiment B16. The method of any one of Example Embodiments B1 to B15, wherein the assistance information comprises at least one angle of a position of the wireless device relative to a RRH.

Example Embodiment B17. The method of any one of Example Embodiments B1 to B16, wherein the assistance information comprises a distance of a RRH from an actual or expected route of the wireless device and/or a vehicle associated with the wireless device.

Example Embodiment B18. The method of any one of Example Embodiments B1 to B17, wherein the assistance information comprises an indication that the wireless device is associated with a high speed train.

Example Embodiment B19. The method of Example Embodiment B18, further comprising configuring the wireless device to determine based on the indication, that the wireless device is traveling at a speed that is greater than a threshold speed.

Example Embodiment B20. The method of Example Embodiment B18, further comprising configuring the wireless device to determine based on the indication, that the wireless device is traveling at a speed that is within a range of speeds that are associated with the high speed train.

Example Embodiment B21. The method of any of Example Embodiments B18 to B20, wherein the method comprises determining the first subset of receive beams in response to receiving the indication the wireless device is associated with the high speed train.

Example Embodiment B22. The method of any one of Example Embodiments B1 to B21, wherein the assistance information comprises an indication of a Doppler frequency and/or Doppler frequency range associated with the wireless device.

Example Embodiment B23. The method of any one of Example Embodiments B1 to B22, further comprising receiving, from the wireless device, an indication of a High Speed Train (HST) class associated with a vehicle associated with the wireless device.

Example Embodiment B24. The method of Example Embodiment B23, further comprising determining the assistance information based on the HST class associated with the wireless device.

Example Embodiment B25. The method of any one of Example Embodiments B1 to B24, wherein the wireless device is in an idle or inactive state, and the method further comprises configuring the wireless device to determine a number of beams in the subset of receive beams based at least in part based on the wireless device being in the idle or inactive state.

Example Embodiment B26. The method of any one of Example Embodiments B1 to B24, wherein the wireless device is in a connected state, and the method further comprises configuring the wireless device to determine a number of beams in the subset of receive beams based at least in part based on the wireless device being in the connected state.

Example Embodiment B27. The method of any one of Example Embodiments B1 to B26, further comprising configuring the wireless device to adapt a Radio Resource Management (RRM) operation based on the first subset of receive beams.

Example Embodiment B28. The method of Example Embodiment B27, wherein configuring the wireless device to adapt the RRM operation comprises configuring the wireless device to perform the receive beam sweeping over a reduced number of beams as compared to a reference number of beams.

Example Embodiment B29. The method of Example Embodiment B28, wherein the reference number of beams is eight, and wherein the reduced number of receive beams is less than eight.

Example Embodiment B30. The method of Example Embodiment B28 or B29, wherein the reference number of beams corresponds to the set of the plurality of beams.

Example Embodiment B31. The method of any of Example Embodiments B27 to A30 when dependent on Example Embodiment A13, wherein the reduced number of beams corresponds to the number of beams over which receive beam sweeping is performed when the assistance information is received, and the reference number of beams corresponds to number of beams over which receive beam sweeping is performed when no assistance information is received by the wireless device.

Example Embodiment B32. The method of Example Embodiment B26 to B31, wherein configuring the wireless device to adapt the RRM operation comprises configuring the wireless device to perform a measurement during an adapted measurement time (Ta), which is shorter than a reference measurement time (Tr) where Tm<Tr.

Example Embodiment B33. The method of Example Embodiment B32, wherein configuring the wireless device to perform the measurement during the reference measurement time comprises configuring the wireless device to perform the measurement when the number of beams over which receive beam sweeping is to be performed corresponds to the reference number of beams.

Example Embodiment B34. The method of Example Embodiment B32, further comprising configuring the wireless device to: perform the measurement during the adapted measurement time when the assistance information is received, and perform the measurement during the reference measurement time when no assistance information is received by the wireless device.

Example Embodiment B35. The method of any one of Example Embodiments B1 to B34, wherein the wireless device comprises a user equipment (UE).

Example Embodiment B36. The method of Example Embodiment B35, wherein the UE is mounted on a train.

Example Embodiment B37. A network node comprising processing circuitry configured to perform any of the methods of Example Embodiments B1 to B36.

Example Embodiment B38. A computer program comprising instructions which when executed on a computer perform any of the methods of Example Embodiments B1 to B36.

Example Embodiment B39. A computer program product comprising computer program, the computer program comprising instructions which when executed on a computer perform any of the methods of Example Embodiments B1 to B36.

Example Embodiment B40. A non-transitory computer readable medium storing instructions which when executed by a computer perform any of the methods of Example Embodiments B1 to B36.

### Group C Example Embodiments

Example Embodiment C1. A wireless device comprising: processing circuitry configured to perform any of the steps of any of the Group A Example Embodiments; and power supply circuitry configured to supply power to the wireless device.

Example Embodiment C2. A network node comprising: processing circuitry configured to perform any of the steps of any of the Group B Example Embodiments; power supply circuitry configured to supply power to the wireless device.

Example Embodiment C3. A wireless device, the wireless device comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A Example Embodiments; an input interface connected to the processing circuitry and configured to allow input of information into the wireless device to be processed by the processing circuitry; an output interface connected to the processing circuitry and configured to output information from the wireless device that has been processed by the processing circuitry; and a battery connected to the processing circuitry and configured to supply power to the wireless device.

Example Embodiment C4. A communication system including a host computer comprising: processing circuitry configured to provide user data; and a communication interface configured to forward the user data to a cellular network for transmission to a wireless device, wherein the cellular network comprises a network node having a radio interface and processing circuitry, the network node's processing circuitry configured to perform any of the steps of any of the Group B Example Embodiments.

Example Embodiment C5. The communication system of the pervious embodiment further including the network node.

Example Embodiment C6. The communication system of the previous 2 embodiments, further including the wireless device, wherein the wireless device is configured to communicate with the network node.

Example Embodiment C7. The communication system of the previous 3 embodiments, wherein: the processing circuitry of the host computer is configured to execute a host application, thereby providing the user data; and the wireless device comprises processing circuitry configured to execute a client application associated with the host application.

Example Embodiment C8. A method implemented in a communication system including a host computer, a network node and a wireless device, the method comprising: at the host computer, providing user data; and at the host computer, initiating a transmission carrying the user data to the wireless device via a cellular network comprising the network node, wherein the network node performs any of the steps of any of the Group B Example Embodiments.

Example Embodiment C9. The method of the previous embodiment, further comprising, at the network node, transmitting the user data.

Example Embodiment C10. The method of the previous 2 embodiments, wherein the user data is provided at the host computer by executing a host application, the method further comprising, at the wireless device, executing a client application associated with the host application.

Example Embodiment C11. A wireless device configured to communicate with a network node, the wireless device comprising a radio interface and processing circuitry configured to performs the of the previous 3 embodiments.

Example Embodiment C12. A communication system including a host computer comprising: processing circuitry configured to provide user data; and a communication interface configured to forward user data to a cellular network for transmission to a wireless device, wherein the wireless device comprises a radio interface and processing circuitry, the wireless device's components configured to perform any of the steps of any of the Group A Example Embodiments.

Example Embodiment C13. The communication system of the previous embodiment, wherein the cellular network further includes a network node configured to communicate with the wireless device.

Example Embodiment C14. The communication system of the previous 2 embodiments, wherein: the processing circuitry of the host computer is configured to execute a host application, thereby providing the user data; and the wireless device's processing circuitry is configured to execute a client application associated with the host application.

Example Embodiment C15. A method implemented in a communication system including a host computer, a network node and a wireless device, the method comprising: at the host computer, providing user data; and at the host computer, initiating a transmission carrying the user data to the wireless device via a cellular network comprising the network node, wherein the wireless device performs any of the steps of any of the Group A Example Embodiments.

Example Embodiment C16. The method of the previous embodiment, further comprising at the wireless device, receiving the user data from the network node.

Example Embodiment C17. A communication system including a host computer comprising: communication interface configured to receive user data originating from a transmission from a wireless device to a network node, wherein the wireless device comprises a radio interface and processing circuitry, the wireless device's processing circuitry configured to perform any of the steps of any of the Group A Example Embodiments.

Example Embodiment C18. The communication system of the previous embodiment, further including the wireless device.

Example Embodiment C19. The communication system of the previous 2 embodiments, further including the network node, wherein the network node comprises a radio interface configured to communicate with the wireless device and a communication interface configured to forward to the host computer the user data carried by a transmission from the wireless device to the network node.

Example Embodiment C20. The communication system of the previous 3 embodiments, wherein: the processing circuitry of the host computer is configured to execute a host application; and the wireless device's processing circuitry is configured to execute a client application associated with the host application, thereby providing the user data.

Example Embodiment C21. The communication system of the previous 4 embodiments, wherein: the processing circuitry of the host computer is configured to execute a host application, thereby providing request data; and the wireless device's processing circuitry is configured to execute a client application associated with the host application, thereby providing the user data in response to the request data.

Example Embodiment C22. A method implemented in a communication system including a host computer, a network node and a wireless device, the method comprising: at the host computer, receiving user data transmitted to the network node from the wireless device, wherein the wireless device performs any of the steps of any of the Group A Example Embodiments.

Example Embodiment C23. The method of the previous embodiment, further comprising, at the wireless device, providing the user data to the network node.

Example Embodiment C24. The method of the previous 2 embodiments, further comprising: at the wireless device, executing a client application, thereby providing the user data to be transmitted; and at the host computer, executing a host application associated with the client application.

Example Embodiment C25. The method of the previous 3 embodiments, further comprising: at the wireless device, executing a client application; and at the wireless device, receiving input data to the client application, the input data being provided at the host computer by executing a host application associated with the client application, wherein the user data to be transmitted is provided by the client application in response to the input data.

Example Embodiment C26. A communication system including a host computer comprising a communication interface configured to receive user data originating from a transmission from a wireless device to a network node, wherein the network node comprises a radio interface and processing circuitry, the network node's processing circuitry configured to perform any of the steps of any of the Group B Example Embodiments.

Example Embodiment C27. The communication system of the previous embodiment further including the network node.

Example Embodiment C28. The communication system of the previous 2 embodiments, further including the wireless device, wherein the wireless device is configured to communicate with the network node.

Example Embodiment C29. The communication system of the previous 3 embodiments, wherein: the processing circuitry of the host computer is configured to execute a host application; the wireless device is configured to execute a client application associated with the host application, thereby providing the user data to be received by the host computer.

Example Embodiment C30. A method implemented in a communication system including a host computer, a network node and a wireless device, the method comprising: at the host computer, receiving, from the base station, user data originating from a transmission which the network node has received from the wireless device, wherein the wireless device performs any of the steps of any of the Group A Example Embodiments.

Example Embodiment C31. The method of the previous embodiment, further comprising at the network node receiving the user data from the wireless device.

Example Embodiment C32. The method of the previous 2 embodiments, further comprising at the network node, initiating a transmission of the received user data to the host computer.

Example Embodiment C33. The method of any of the previous embodiments, wherein the network node comprises a base station.

Example Embodiment C34. The method of any of the previous embodiments, wherein the wireless device comprises a user equipment (UE).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method by a wireless device operable to perform receive beam sweeping over a set of a plurality of receive beams, the method comprising:
receiving, from a network node, assistance information;
determining, based on the assistance information, a first subset of receive beams within the set of the plurality of receive beams; and
performing at least one operation based on the first subset of receive beams.

2. The method of claim 1, wherein performing the at least one operation comprises performing at least one measurement based on the first subset of receive beams.

3. The method of claim 1, wherein the first subset of receive beams comprises fewer beams than the set of the plurality of receive beams.

4. The method of claim 1, wherein the first subset of receive beams comprises all of the set of the plurality of receive beams.

5. The method of claim 1, wherein the assistance information comprises at least one of: an estimated position of the wireless device; an actual position of the wireless device; an estimated speed of the wireless device; an actual speed of the wireless device; geographical information associated with a network deployment; a position of an antenna of at least one network node; an actual or expected route of a vehicle on which the wireless device is mounted; a distance of at least one network node from the wireless device; a distance of at least one network node from a route of the vehicle on which the wireless device is mounted; and vehicle deployment and/or vehicle layout information.

6. The method of claim 1, wherein the assistance information comprises at least one of: Dmin, Ds, Drrh_h, and a geographical coordinate of a location of at least one network node, where Dmin is a perpendicular distance between the at least one network node and track on which the vehicle travels; Ds is the distance between adjacent at least one network node and Drrh_h is the vertical height of the at least one network node above the ground.

7. The method of claim 1, further comprising determining, based on the assistance information, a location of at least one network node relative to the wireless device.

8. The method of claim 1, wherein the assistance information comprises at least one angle of a position of the wireless device relative to at least one network node.

9. The method of claim 1, wherein the assistance information comprises a distance of at least one network node from an actual or expected route of the wireless device and/or a vehicle associated with the wireless device.

10. The method of claim 1, wherein the assistance information comprises an indication that the wireless device is traveling at a speed that is greater than a threshold speed or within a range of speeds that are associated with a high speed vehicle.

11. The method of claim 10, wherein the method comprises determining the first subset of receive beams in response to receiving the indication the wireless device is traveling at a speed that is greater than a threshold speed or is travelling at a speed that is within a range of speeds that are associated with the high speed vehicle.

12. The method of claim 1, wherein performing the at least one operation comprises adapting a Radio Resource Management, RRM, operation based on the first subset of receive beams.

13. The method of claim 12, wherein adapting the RRM operation comprises performing the receive beam sweeping over a reduced number of beams as compared to a reference number of beams.

14. The method of claim 13, wherein the reduced number of beams corresponds to the number of beams over which receive beam sweeping is performed when the assistance information is received, and the reference number of beams corresponds to number of beams over which receive beam sweeping is performed if no assistance information was received by the wireless device.

15. The method of claim 1, wherein the wireless device comprises a user equipment, UE, mounted on a vehicle.

16. A method by a network node operable to assist a wireless device in performing receive beam sweeping over a set of a plurality of receive beams, the method comprising:
transmitting, to the wireless device, assistance information for determining by the wireless device a first subset of receive beams within the set of the plurality of receive beams for performing receive beam sweeping.

17. (canceled)

18. (canceled)

19. The method of claim 16, wherein the assistance information comprises at least one of: an estimated position of the wireless device; an actual position of the wireless device; an estimated speed of the wireless device; an actual speed of the wireless device; geographical information associated with a network deployment; a position of an antenna of at least one network node; an actual or expected route of a vehicle on which the wireless device is mounted; a distance of at least one network node from the wireless device; a distance of at least one network node from a route of the vehicle on which the wireless device is mounted; and vehicle deployment and/or vehicle layout information.

20. The method of claim 16, wherein the assistance information comprises at least one of: Dmin, Ds, Drrh_h, and a geographical coordinate of a location of at least one network node, where Dmin is a perpendicular distance between the at least one network node and track on which the vehicle travels; Ds is the distance between adjacent at least one network node and Drrh_h is the vertical height of the at least one network node above the ground.

21. (canceled)

22. The method of claim 16, wherein the assistance information comprises at least one angle of a position of the wireless device relative to at least one network node.

23.-28. (canceled)

29. A wireless device adapted to perform the method of claim 1.

30. (canceled)
